(19) United States
(12) Patent Application Publication
(10) Pub. No.: US 2025/0365130 A1
(43) Pub. Date: Nov. 27, 2025

(54) AUTHENTICATED ENCRYPTION APPARATUS, AUTHENTICATED DECRYPTION APPARATUS, AUTHENTICATED ENCRYPTION SYSTEM, METHOD, AND NON-TRANSITORY COMPUTER READABLE MEDIUM

(71) Applicant: NEC Corporation, Tokyo (JP)

(72) Inventors: Akiko Mukai, Tokyo (JP); Kazuhiko Minematsu, Tokyo (JP)

(73) Assignee: NEC Corporation, Tokyo (JP)

(21) Appl. No.: 18/670,823

(22) Filed: May 22, 2024

(51) Int. Cl. H04L 9/06

(52) U.S. Cl. CPC H04L 9/0618

(57) ABSTRACT

A plaintext division unit divides a plaintext into a first plaintext and a second plaintext at a predetermined ratio. A first encryption unit acquires a first ciphertext by an encryption function by using a mask value obtained based on a first value and a plurality of plaintext blocks, respectively. A second encryption unit acquires a second ciphertext by using, among encryption results output from the encryption function in the encryption of the first plaintext, a value other than a value used for the encryption of the first plaintext and a second plaintext. An authentication tag generation unit generates a first tag. The authentication tag generation unit generates a second tag. The authentication tag generation unit generates an authentication tag.

### INCORPORATION BY REFERENCE

This application is based upon and claims the benefit of priority from Japanese patent application No. 2023-92732, filed on Jun. 5, 2023, the disclosure of which is incorporated herein in its entirety by reference.

### TECHNICAL FIELD

The present disclosure relates to an authenticated encryption apparatus, an authenticated decryption apparatus, an authenticated encryption system, a method, and a program.

### BACKGROUND ART

Authenticated encryption (AE; Authenticated Encryption) in which encryption and authentication-tag calculation for detecting tampering are simultaneously performed on a plaintext message by using a private key that is shared in advance has been known. By applying the authenticated encryption AE to a communication channel, it is possible to conceal information and the like against eavesdropping and detect unauthorized tampering made thereto, and as a result, strong protection for communicated information and the like is realized.

As technologies related to such authenticated encryption, for example, those disclosed in Japanese Unexamined Patent Application Publication No. 2016-075765 and NPL 1 (Y. Nir, and A. Langley, “ChaCha20 and Poly1305 for IETF Protocols”, June 2018, https://www.rfc-editor.org/rfc/rfc8439.html), NPL 2 (Daniel J. Bernstein, “ChaCha, a variant of Salsa20”, 2008 Jan. 20, https://cr.yp.to/chacha/chacha-20080120.pdf), NPL 3 (Daniel J. Bernstein, “The Poly1305-AES Message-Authentication Code”, 2005 Mar. 29, https://link.springer.com/chapter/10.1007/11502760_3), NPL 4 (Daniel J. Bernstein, “The Salsa20 family of stream ciphers”, 2007 Dec. 25, http://cr.yp.to/snuffle/salsafamily-20071225.pdf), NPL 5 (Daniel J. Bernstein, “Extending the Salsa20 nonce”, 2008 Nov. 28, https://cr.yp.to/snuffle/xsalsa-20081128.pdf) and NPL 6 (S. Arciszewski, “XChaCha: extended-nonce ChaCha and AEAD_XChaCha20_Polyl305”, Jan. 10, 2020, https://datatracker.ietf.org/doc/html/draft-irtf-cfrg-xchacha-03) have been known.

NPL 1 discloses an authenticated encryption method called “ChaCha20-Poly1305”. “ChaCha20-Polyl305” is a technology in which an encryption method called “ChaCha20” is combined with a tampering detection method called “Polyl305”. According to “ChaCha20-Polyl305”, an encrypting process is performed by using a cryptographic primitive (cryptopart) of which the output length is longer than the input length. “ChaCha20” is disclosed, for example, in NPL 2. “Polyl305” is disclosed, for example, in NPL 3. Further, NPL 4 discloses an encryption method “SalSa20” related to “ChaCha20”. Further, NPL 5 discloses an encryption method “XSalSa20” which is an improved version of “SalSa20”. Further, NPL 6 discloses an encryption method “XChaCha20” which is an improved version of “ChaCha20”. Further, Japanese Unexamined Patent Application Publication No. 2016-075765 discloses an authenticated encryption method called an OTR (Offset Two-Round) method. The OTR is an authenticated encryption method by which authenticated encryption can be carried out at only a computational cost required for the encryption of a plaintext.

In the technology disclosed in NPL 1, after a plaintext is encrypted into a ciphertext, a tag for detecting tampering is generated by using the ciphertext. Therefore, both the encryption of the plaintext and the generation of the tag incur respective computational costs the amounts of which are substantially equal to each other. Accordingly, it may not be possible to efficiently perform an authenticated encryption process in the technology disclosed in NPL 1 compared with the method for carrying out authenticated encryption in which only the computational cost for the encryption of a plaintext incurs.

### SUMMARY

The present disclosure has been made to solve the above-described problem, and an object thereof is to provide an authenticated encryption apparatus, an authenticated decryption apparatus, an authenticated encryption system, a method, and a program capable of efficiently performing an authenticated encryption process by using a cryptographic primitive of which the output length is longer than the input length.

An authenticated encryption apparatus according to the present disclosure includes: plaintext division means for dividing a plaintext into a first plaintext and a second plaintext at a predetermined ratio; first encryption means for acquiring, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquiring a first ciphertext in which the first plaintext is encrypted; second encryption means for acquiring, by using, among encryption results output from the encryption function in the encryption of the first plaintext, a value other than a value used for the encryption of the first plaintext and the second plaintext, a second ciphertext in which the second plaintext is encrypted; and authentication tag generation means for generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating an authentication tag.

Further, an authenticated decryption apparatus according to the present disclosure includes: ciphertext division means for dividing a ciphertext into a first ciphertext and a second ciphertext at a predetermined ratio; first decryption means for acquiring, by an encryption function corresponding to a cryptographic primitive of which an output length is longer than an input length and by using a mask value obtained based on a first value obtained by encrypting a nonce using the encryption function and a plurality of ciphertext blocks, respectively, obtained by dividing the first ciphertext into blocks each having a length corresponding to the input length, a plurality of plaintext blocks corresponding to the plurality of ciphertext blocks, and thereby acquiring a first plaintext obtained by decrypting the first ciphertext; second decryption means for acquiring, by using, among encryption results output from the encryption function in the decryption of the first ciphertext, a value other than a value used for the decryption of the first ciphertext and the second ciphertext, a second plaintext obtained by decrypting the second ciphertext; verification tag generation means for generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating a verification tag; and verification means for verifying whether tempering has occurred or not by comparing the verification tag with an input authentication tag, and performing control for outputting a verification result.

Further, an authenticated encryption system according to the present disclosure includes: an authenticated encryption apparatus; and an authenticated decryption apparatus configured to communicate with the authenticated encryption apparatus, in which the authenticated encryption apparatus includes: plaintext division means for dividing a plaintext into a first plaintext and a second plaintext at a predetermined ratio; first encryption means for acquiring, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquiring a first ciphertext in which the first plaintext is encrypted; second encryption means for acquiring, by using, among encryption results output from the encryption function in the encryption of the first plaintext, a value other than a value used for the encryption of the first plaintext and the second plaintext, a second ciphertext in which the second plaintext is encrypted; and authentication tag generation means for generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating an authentication tag, and the authenticated decryption apparatus includes: ciphertext division means for dividing a ciphertext into a first ciphertext and a second ciphertext at a predetermined ratio; first decryption means for acquiring, by the encryption function and by using the mask value obtained based on the first value obtained by encrypting the nonce using the encryption function and a plurality of ciphertext blocks, respectively, obtained by dividing the first ciphertext into blocks each having a length corresponding to the input length, a plurality of plaintext blocks corresponding to the plurality of ciphertext blocks, and thereby acquiring a first plaintext obtained by decrypting the first ciphertext; second decryption means for acquiring, by using, among encryption results output from the encryption function in the decryption of the first ciphertext, a value other than a value used for the decryption of the first ciphertext and the second ciphertext, a second plaintext obtained by decrypting the second ciphertext; verification tag generation means for generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating a verification tag; and verification means for verifying whether tempering has occurred or not by comparing the verification tag with an input authentication tag, and performing control for outputting a verification result.

Further, an authenticated encryption method according to the present disclosure includes: dividing a plaintext into a first plaintext and a second plaintext at a predetermined ratio; acquiring, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquiring a first ciphertext in which the first plaintext is encrypted; acquiring, by using, among encryption results output from the encryption function in the encryption of the first plaintext, a value other than a value used for the encryption of the first plaintext and the second plaintext, a second ciphertext in which the second plaintext is encrypted; and generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating an authentication tag.

Further, an authenticated decryption method according to the present disclosure includes: dividing a ciphertext into a first ciphertext and a second ciphertext at a predetermined ratio; acquiring, by an encryption function corresponding to a cryptographic primitive of which an output length is longer than an input length and by using a mask value obtained based on a first value obtained by encrypting a nonce using the encryption function and a plurality of ciphertext blocks, respectively, obtained by dividing the first ciphertext into blocks each having a length corresponding to the input length, a plurality of plaintext blocks corresponding to the plurality of ciphertext blocks, and thereby acquiring a first plaintext obtained by decrypting the first ciphertext; acquiring, by using, among encryption results output from the encryption function in the decryption of the first ciphertext, a value other than a value used for the decryption of the first ciphertext and the second ciphertext, a second plaintext obtained by decrypting the second ciphertext; generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating a verification tag; and verifying whether tempering has occurred or not by comparing the verification tag with an input authentication tag, and performing control for outputting a verification result.

Further, a program according to the present disclosure causes a computer to perform: a step of dividing a plaintext into a first plaintext and a second plaintext at a predetermined ratio; a step of acquiring, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquiring a first ciphertext in which the first plaintext is encrypted; a step of acquiring, by using, among encryption results output from the encryption function in the encryption of the first plaintext, a value other than a value used for the encryption of the first plaintext and the second plaintext, a second ciphertext in which the second plaintext is encrypted; and a step of generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating an authentication tag.

Further, a program according to the present disclosure causes a computer to perform: a step of dividing a ciphertext into a first ciphertext and a second ciphertext at a predetermined ratio; a step of acquiring, by an encryption function corresponding to a cryptographic primitive of which an output length is longer than an input length and by using a mask value obtained based on a first value obtained by encrypting a nonce using the encryption function and a plurality of ciphertext blocks, respectively, obtained by dividing the first ciphertext into blocks each having a length corresponding to the input length, a plurality of plaintext blocks corresponding to the plurality of ciphertext blocks, and thereby acquiring a first plaintext obtained by decrypting the first ciphertext; a step of acquiring, by using, among encryption results output from the encryption function in the decryption of the first ciphertext, a value other than a value used for the decryption of the first ciphertext and the second ciphertext, a second plaintext obtained by decrypting the second ciphertext; a step of generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating a verification tag; and a step of verifying whether tempering has occurred or not by comparing the verification tag with an input authentication tag, and performing control for outputting a verification result.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 shows a configuration of an authenticated encryption apparatus according to the present disclosure;

FIG. 2 shows a configuration of an authenticated encryption apparatus according to the present disclosure;

FIG. 3 shows a configuration of an authenticated encryption system according to the present disclosure;

FIG. 4 shows a configuration of an authenticated encryption apparatus according to the present disclosure;

FIG. 5 shows an outline of an operation in an authenticated encryption process performed by the authenticated encryption apparatus according to the present disclosure;

FIG. 6 shows an outline of an operation in the authenticated encryption process performed by the authenticated encryption apparatus according to the present disclosure;

FIG. 7 shows an outline of an operation in the authenticated encryption process performed by the authenticated encryption apparatus according to the present disclosure;

FIG. 8 shows an outline of an operation in the authenticated encryption process performed by the authenticated encryption apparatus according to the present disclosure;

FIG. 9 shows an outline of an operation in the authenticated encryption process performed by the authenticated encryption apparatus according to the present disclosure;

FIG. 10 shows an outline of an operation in the authenticated encryption process performed by the authenticated encryption apparatus according to the present disclosure;

FIG. 11 shows a configuration of an authenticated decryption apparatus according to the present disclosure;

FIG. 12 shows an outline of an operation in an authenticated decryption process performed by the authenticated decryption apparatus according to the present disclosure;

FIG. 13 shows an outline of an operation in the authenticated decryption process performed by the authenticated decryption apparatus according to the present disclosure;

FIG. 14 shows an outline of an operation in the authenticated decryption process performed by the authenticated decryption apparatus according to the present disclosure;

FIG. 15 shows an outline of an operation in the authenticated decryption process performed by the authenticated decryption apparatus according to the present disclosure;

FIG. 16 shows an outline of an operation in the authenticated decryption process performed by the authenticated decryption apparatus according to the present disclosure;

FIG. 17 is a flowchart showing an authenticated encryption method performed by the authenticated encryption apparatus according to the present disclosure;

FIG. 18 is a flowchart showing an authenticated decryption method performed by the authenticated decryption apparatus according to the present disclosure;

FIG. 19 is a diagram for explaining a second modified example;

FIG. 20 shows a configuration of an authenticated encryption apparatus according to the present disclosure;

FIG. 21 shows an outline of an operation in an authenticated encryption process performed by the authenticated encryption apparatus according to the present disclosure;

FIG. 22 shows a configuration of an authenticated decryption apparatus according to the present disclosure;

FIG. 23 shows a configuration of an authenticated encryption apparatus according to the present disclosure;

FIG. 24 shows a configuration of an authenticated decryption apparatus according to the present disclosure; and

FIG. 25 is a block diagram schematically showing an example of a hardware configuration of a calculation processing apparatus capable of implementing an apparatus and a system according to the present disclosure.

### EXAMPLE EMBODIMENT

### (Outline of Example Embodiment)

Prior to describing an example embodiment, an outline of an example embodiment will be described. Note that although example embodiments will be described hereinafter, the following example embodiments are not intended to limit the invention specified by the claims. Further, not all combinations of features described in the example embodiments are essential for the means for solving the invention. Further, indices (alphabet) used in the following description may not be common throughout this specification. For example, an index i in one context and another index i in another context may refer to elements or the like different from each other. Further, it should be noted that although example embodiments are described by using the drawings, each of the drawings used in the description of a respective one of the example embodiments do not necessarily apply only to that example embodiment. That is, each of the drawings may apply to any of the example embodiments.

Firstly, an outline of inputs and outputs of authenticated encryption (AE) will be described. Note that in the following description, communication between two persons, Alice and Bob, both of whom share (i.e., possess) a private key K, is assumed. Further, it is assumed that a message that has been encrypted by authenticated encryption is transmitted from Alice to Bob.

An encryption function and a decryption function of the authenticated encryption are represented by Enc and Dec, respectively. Further, a plaintext to be encrypted is represented by M, and a variable N (initial vector) called a Nonce is introduced. Further, associated data (AD; Associated Data) is represented by A. Note that the associated data A (header) is a value which is not encrypted, but it is detected whether or not this value has been tampered with. The associated data A is not indispensable.

Firstly, encryption processing on the Alice side will be described. After generating a nonce N, Alice carries out processing expressed as (C, T)=Enc_K (N, A, M). Note that Enc_K is an encryption function in which a key K, which is a private key, is used as a parameter, and C is a ciphertext. Further, Tis a variable having a fixed length for detecting tampering, and is called a tag (authentication tag). Alice transmits a set of the nonce N, the associated data A, the ciphertext C, and the tag T (N, A, C, T) to Bob.

Next, decryption processing on the Bob side will be described. Information received by Bob is represented by (N′, A′, C′, T′). In this case, Bob carries out a function Dec_K (N′, A′, C′, T′) as decryption processing. Note that Dec_K is a decryption function in which the key K is used as a parameter. When tampering by a third party, Eve, has occurred during the communication and hence (N′, A′, C′, T′) is not equal to (N, A, C, T) ((N′, A′, C′, T′)≠(N, A, C, T)), an error message (error symbol ⊥) indicating that the tampering has occurred for Dec_K (N′, A′, C′, T′) is output. That is, in this case, the tampering is detected. On the other hand, when no tampering has occurred during the communication and hence (N′, A′, C′, T′) is equal to (N, A, C, T) ((N′, A′, C′, T′)=(N, A, C, T)), the plaintext M encrypted by Alice is correctly decrypted by Dec_K (N′, A′, C′, T′).

Further, in the above-described processing, in general, it is important to prevent the nonce N from coinciding with any of its past values in the encryption. Therefore, on the encryption side, the nonce is prevented from coinciding with any of its past values by using some state variable such as a counter value. That is, typically, the nonce N that has been used in the last encryption is recorded as a state variable and this number N is incremented each time encryption is performed, so that the nonce N does not coincide with any of its past values.

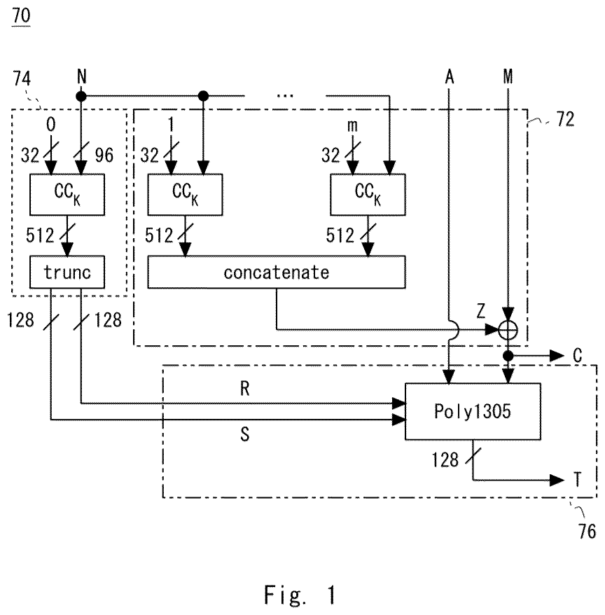

FIG. 1 shows a configuration of an authenticated encryption apparatus 70 according to the present disclosure. The authenticated encryption apparatus 70 according to a first comparative example is implemented by using an authenticated encryption method according to ChaCha20-Polyl305 disclosed in NPL 1. Further, FIG. 1 shows an outline of an operation performed by the authenticated encryption apparatus 70 according to the present disclosure. Note that in the following description, “ChaCha20-Polyl305” may be referred to simply as “CP”. The authenticated encryption apparatus 70 according to the first comparative example includes an encryption unit 72, a key generation unit 74, and a tag generation unit 76.

The encryption unit 72 performs encryption, by the above-described encryption method according to ChaCha20, using a random function CC_K. Note that the random function CC_K is an encryption function (cryptographic primitive) of which the input length is 128 bits and the output length is 512 bits. Therefore, the random function CC_K is a cryptographic primitive of which the input length is longer than the output length. Further, a 256-bit key K is input to the random function CC_K. Further, the random function CC_K is a function of which an output value is apparently random for an input value. Further, it is extremely difficult to obtain the input value of the random function CC_K from the output value thereof. Further, random functions CC_K to which different keys are input can be regarded as being functions independent of each other.

The encryption unit 72 generates a key stream Z necessary for the encryption of a plaintext M in a counter mode using the random function CC_K. Then, the encryption unit 72 encrypts the plaintext M by using the key stream Z and thereby acquires a ciphertext C.

Here, assume that the length of the plaintext M is 512×m bits. That is, m corresponds to the number of blocks when the plaintext M is divided into 512-bit plaintext blocks. In this case, the encryption unit 72 inputs 32-bit counter values “1”, “2”, . . . , and “m” to m random functions CC_K, respectively, and also inputs a 96-bit nonce N to each of the m random functions CC_K. Then, the encryption unit 72 acquires a key stream Z consisting of 512×m bits which is obtained by concatenating values output from the random functions CC_K. Then, the encryption unit 72 acquires a ciphertext C by calculating an exclusive OR (XOR) between the plaintext M and the key stream Z.

The key generation unit 74 generates keys R and S which are used in the tag generation unit 76. Specifically, the key generation unit 74 inputs a 32-bit counter value “0” and a nonce N to the random function CC_K. Then, the key generation unit 74 divides the upper 256 bits of an output value of the random function CC_K into 128-bit values, and thereby generates keys R and S each consisting of 128 bits.

The tag generation unit 76 generates an authentication tag T by the above-described tampering detection method according to Polyl305. Specifically, the tag generation unit 76 inputs a ciphertext C, associated data A, and keys R and S into a MAC (Message Authentication Code) function according to Polyl305. In this way, the tag generation unit 76 acquires a 128-bit tag T output from the MAC function. Note that when there is no associated data A, no associated data A may be input to the MAC function.

More specifically, when there is no associated data A, the tag generation unit 76 acquires a tag T by calculating the sum, in mod (2\hat{ }128), of an output H_R(C) of a polynomial hash function, which is defined by the key R, and the key S. That is, the tag generation unit 76 acquires a tag T by performing an operation defined by mod (2\hat{ }128) by using the output H_R(C) of the polynomial hash function, which is defined by the key R, and the key S. That is, the below-shown Expression (1) holds.

$$[ Expression 1 ]$$

$$T = {H}_{R} ( C ) + S mod ( {2}^{128} ) \qquad ( 1 )$$

Further, the output H_R(C) of the polynomial hash function is expressed by the below-shown Expression (2).

$$[ Expression 2 ]$$

$${H}_{R} ( C ) = C [ 1 ] \cdot {R}^{m} + C [ 2 ] \cdot {R}^{m - 1} + ⋯ + C [ m ] \cdot R mod ( {2}^{130} - 5 ) \qquad ( 2 )$$

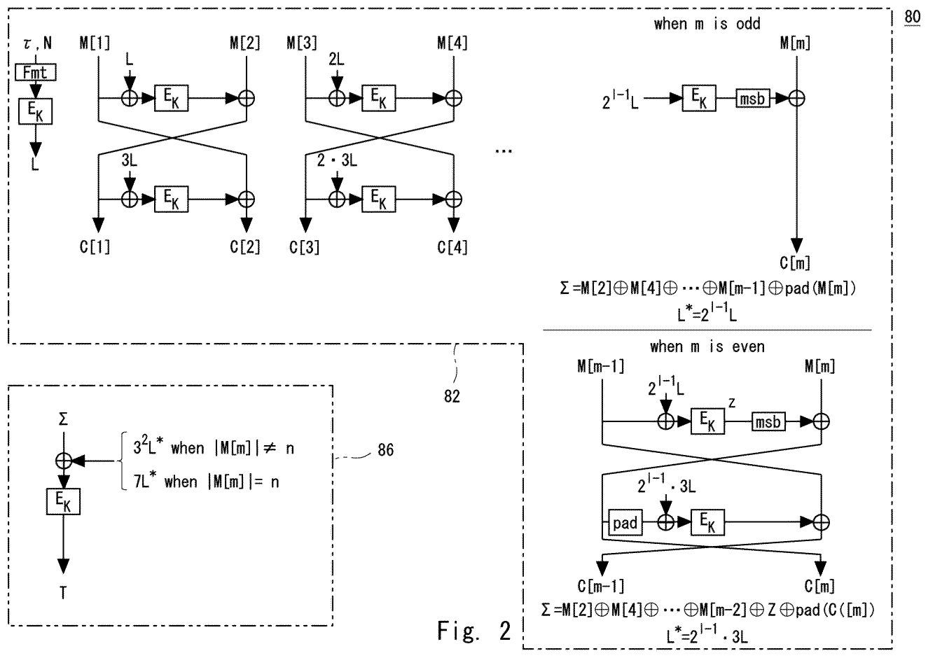

FIG. 2 shows a configuration of an authenticated encryption apparatus 80 according to the present disclosure. The authenticated encryption apparatus 80 according to a second comparative example is implemented by using an authenticated encryption method according to the OTR method disclosed in Japanese Unexamined Patent Application Publication No. 2016-075765. Further, FIG. 2 shows an outline of an operation performed by the authenticated encryption apparatus 80 according to the present disclosure.

Note that the OTR method is an authenticated encryption method in which a block cipher is used as a cryptopart (cryptographic primitive). Further, the OTR method is an authenticated encryption method according to a “Rate−1 method” in which the encryption rate is “1”. That is, the OTR method is an authenticated encryption method in which a block cipher is used only once for one plaintext block. Further, in the OTR method, encryption is performed by a two-stage Feistel structure. Therefore, the same cryptopart (encryption function) is used in both the encryption process and the decryption process. That is, the decryption function, which is an inverse function of the encryption function used in the encryption process, is not required in the decryption process. By the above-described configuration, the OTR method makes it possible to carry out authenticated encryption with an amount of processing equivalent to that in the use mode in which only encryption is performed.

The authenticated encryption apparatus 80 according to the second comparative example includes an encryption unit 82 and a tag generation unit 86. The encryption unit 82 and the tag generation unit 86 use, as a cryptopart (encryption function), a block encryption function E_K of which the input length and the output length are both n bits.

As described above, the encryption unit 82 encrypts a plaintext by using a two-stage Feistel structure. Specifically, the encryption unit 82 encrypts a nonce N by using the block encryption function E_K, and thereby acquires a value L. When the encryption unit 82 encrypts a plaintext, it uses an exclusive OR of a mask value derived from the value L for the input to the block encryption function E_K in the two-stage Feistel structure. Note that mask values corresponding to respective block encryption functions E_K need to be different from each other.

Specifically, the encryption unit 82 encrypts, by the two-stage Feistel structure, each of a pair of an odd-numbered plaintext block M[2j−1] and a next even-numbered plaintext block M[2j] in the plaintext blocks M[1], . . . , and M[m]. Note that j is an integer between 1 and 1 (inclusive). Further, when m is an even number, 1 is expressed as 1=m/2, whereas when m is an odd number, 1 is expressed as 1=(m+1)/2.

The encryption unit 82 inputs an exclusive OR of a plaintext block M[1] and a mask value L to the block encryption function E_K, and thereby acquires an encryption result E_K(L, M[1]). Then, the encryption unit 82 acquires an exclusive OR of the encryption result E_K(L, M[1]) and a plaintext block M[2] as a ciphertext block C[1] corresponding to the plaintext block M[1]. Further, the encryption unit 82 inputs an exclusive OR of the ciphertext block C[1] and a mask value 3L to the block encryption function E_K, and thereby acquires an encryption result E_K(3L, C[1]). Then, the encryption unit 82 acquires an exclusive OR of the encryption result E_K(3L, C[1]) and the plaintext block M[1] as a ciphertext block C[2] corresponding to the plaintext block M[2].

Further, the encryption unit 82 inputs an exclusive OR of a plaintext block M[3] and a mask value 2L to the block encryption function E_K, and thereby acquires an encryption result E_K(2L, M[3]). Then, the encryption unit 82 acquires an exclusive OR of the encryption result E_K(2L, M[3]) and a plaintext block M[4] as a ciphertext block C[3] corresponding to the plaintext block M[3]. Further, the encryption unit 82 inputs an exclusive OR of the ciphertext block C[3] and a mask value 2·3L to the block encryption function E_K, and thereby acquires an encryption result E_K(2·3L, C[3]). Then, the encryption unit 82 acquires an exclusive OR of the encryption result E_K(2·3L, C[3]) and the plaintext block M[3] as a ciphertext block C[4] corresponding to the plaintext block M[4].

After that, similarly, the encryption unit 82 inputs an exclusive OR of a plaintext block M[2j−1] and a mask value 2\hat{ }(j−1)·L to the block encryption function E_K, and thereby acquires an encryption result E_K(2\hat{ }(j−1)·L, M[2j−1]). Then, the encryption unit 82 acquires an exclusive OR of the encryption result E_K(2\hat{ }(j−1)·L, M[2j−1]) and a plaintext block M[2j] as a ciphertext block C[2j−1] corresponding to the plaintext block M[2j−1]. Further, the encryption unit 82 inputs an exclusive OR of the ciphertext block C[2j−1] and a mask value 2\hat{ }(j−1). 3L to the block encryption function E_K, and thereby acquires an encryption result E_K(2\hat{ }(j−1)·3L, C[2j−1]). Then, the encryption unit 82 acquires an exclusive OR of the encryption result E_K(2\hat{ }(j−1)·3L, C[2j−1]) and the plaintext block M[2j−1] as a ciphertext block C[2j] corresponding to the plaintext block M[2j].

Note that the processing for the last plaintext block is changed according to whether m is an odd number or an even number. When m is an even number, the encryption unit 82 inputs an exclusive OR of a plaintext block M[m−1] and a mask value 2\hat{ }(l−1)·L to the block encryption function E_K, and thereby acquires an encryption result Z. Note that Z is expressed as Z=E_K(2\hat{ }(l−1)·L, M[m−1]). Note that the bit length x of the last plaintext block M[m] may be less than n bits. Therefore, the encryption unit 82 acquires msb{|M[m]|} (Z) obtained by truncating the encryption result Z so that it has a bit length equal to the bit length x (1≤x≤n) of the plaintext block M[m]. Note that msb{|M[m]|} (Z) is a bit string consisting of the upper x bits of the encryption result Z. Further, x is expressed as x=|M[m]|. That is, |M[i]| indicates the bit length of a bit string M[i].

Then, the encryption unit 82 acquires an exclusive OR of msb{|M[m]|} (Z) and a plaintext block M[m] as a ciphertext block C[m] corresponding to the plaintext block M[m]. Note that the number of bits of the ciphertext block C[m] is equal to the number of bits of the plaintext block M[m]. Further, the encryption unit 82 performs a padding process such as a one-zero padding process on the ciphertext block C[m], and thereby acquires a n-bit bit string pad (C[m]) corresponding to the ciphertext block C[m]. Further, the encryption unit 82 inputs an exclusive OR of the bit string pad (C[m]) and a mask value 2\hat{ }(l−1)·3L to the block encryption function E_K, and thereby acquires an encryption result E_K(2\hat{ }(l−1)·3L, pad (C[m])). Then, the encryption unit 82 acquires an exclusive OR of the encryption result E_K(2\hat{ }(l−1)·3L, pad (C[m])) and a plaintext block M[m−1] as a ciphertext block C[m−1] corresponding to the plaintext block M[m−1].

When m is an odd number, the encryption unit 82 inputs a mask value 2\hat{ }(l−1). L to the block encryption function E_K, and thereby acquires an encryption result E_K(2\hat{ }(l−1)·L). Then, the encryption unit 82 acquires msb{|M[m]|}(E_K(2\hat{ }(l−1)·L)) obtained by truncating the encryption result E_K(2\hat{ }(l−1)·L) so that it has a bit length equal to the bit length x of the plaintext block M[m]. Then, the encryption unit 82 acquires an exclusive OR of msb{|M[m]|} (E_K(2\hat{ }(l−1)·L)) and a plaintext block M[m] as a ciphertext block C[m] corresponding to the plaintext block M[m]. Note that the number of bits of the ciphertext block C[m] is equal to the number of bits of the plaintext block M[m].

The tag generation unit 86 acquires a checksum Σ by calculating an exclusive OR of even-numbered plaintext blocks. When m is an even number, the checksum Σ is expressed by the below-shown Expression 3. Note that a circled “+” represents an exclusive OR (XOR).

$$[ Expression 3 ]$$

$$Σ = M [ 2 ] ⊕ M [ 4 ] ⊕ ⋯ ⊕ M [ m - 2 ] ⊕ Z ⊕ pad ( C [ m ] ) \qquad ( 3 )$$

When m is an odd number, the checksum Σ is expressed by the below-shown Expression 4.

$$[ Expression 4 ]$$

$$Σ = M [ 2 ] ⊕ M [ 4 ] ⊕ ⋯ ⊕ M [ m - 1 ] ⊕ pad ( M [ m ] ) \qquad ( 4 )$$

The tag generation unit 86 acquires, as an authentication tag T, an encryption result obtained by inputting an exclusive OR of the obtained checksum Σ and an appropriate mask value to the block encryption function E_K. Note that when |M[m]| is not equal to n (|M[m]|≠n), i.e., when the number of bits of the last plaintext block M[m] is not n, the “appropriate mask value” is 3²L*. Further, when |M[m]| is equal to n (|M[m]|=n), i.e., when the number of bits of the last plaintext block M[m] is n, the “appropriate mask value” is 7L*. Note that when m is an even number, L* is expressed as L*=2\hat{ }(l−1)·3L. Further, when m is an odd number, L* is expressed as L*=2\hat{ }(l−1)·L.

Note that a problem in the first comparative example will be described in view of the computational cost. The OTR method according to the second comparative example is an authenticated encryption method according to the “Rate-1 method” in which the encryption rate is “1”. In contrast, in the ChaCha20-Polyl305 method according to the first comparative example, after a plaintext is encrypted into a ciphertext, a tag for detecting tampering is generated by using the ciphertext. Therefore, in the ChaCha-Polyl305 method according to the first comparative example, the computational cost for the plaintext length is increased compared with the Rate-1 method. That is, in the ChaCha-Polyl305 method according to the first comparative example, an authenticated encryption process may not be efficiently performed compared with the Rate-1 method. Therefore, even when a cryptographic primitive used in the ChaCha-Polyl305 method according to the first comparative example are used, it is desired to reduce the computational cost as close to the computational cost of the Rate-1 method as possible. Further, the cryptographic primitive used in the ChaCha-Poly1305 method according to the first comparative example is a random function CC_K for which there is no decryption function. Therefore, it is desired to reduce the computation cost as close to that of the Rate-1 method as possible even when a cryptographic primitive for which there is no decryption function is used.

To cope with this, as will be described hereinafter, in this example embodiment, the cryptographic primitive used in the OTR method according to the second comparative example is replaced by a cryptographic primitive such as the one used in the ChaCha20-Polyl305 method according to the first comparative example. In other words, in this example embodiment, the block encryption function E_K used in the OTR method according to the second comparative example is replaced by a cryptographic primitive such as the random function CC_K used in the ChaCha20-Polyl305 method according to the first comparative example. Note that while the input length of the random function CC_K is 128 bits, the output length thereof is 512 bits. Therefore, if the block encryption function E_K used in the OTR method is simply replaced by the random function CC_K, there is an excess of a bit string consisting of 384 bits corresponding to the difference between the output length and the input length. Therefore, an apparatus according to this example embodiment performs an authenticated encryption process by also using this excess bit string consisting of 384 bits.

That is, the apparatus according to this example embodiment divides a plaintext into a first plaintext and a second plaintext. The apparatus according to this example embodiment generates, for the first plaintext, a first ciphertext and a first tag by using a configuration in which the block encryption function E_K used in the OTR method is replaced by the random function CC_K. That is, the apparatus according to this example embodiment performs processing corresponding to the above-described OTR method for the first plaintext. However, the apparatus according to this example embodiment uses, when it encrypts the first plaintext, a cryptographic primitive, such as the random function CC_K, of which the output length is longer than the input length. Note that the apparatus according to this example embodiment does not necessarily have to use the random function CC_K as the cryptographic primitive when it encrypts the first plaintext. That is, the apparatus according to this example embodiment may use a cryptographic primitive other than the random function CC_K, provided that its output length is longer than its input length.

Further, the apparatus according to this example embodiment generates a second ciphertext and a second tag by using the second plaintext and the above-described excess bit string consisting of 384 bits. That is, the apparatus according to this example embodiment uses the concatenation of the excess bit string as a key stream and generates a second ciphertext by an exclusive OR of the second plaintext and this key stream. Note that the apparatus according to this example embodiment generates a second tag by inputting the second ciphertext to the MAC function according to Polyl305. That is, the apparatus according to this example embodiment performs processing corresponding to the above-described ChaCha20-Polyl305 for the second plaintext.

By the above-described configuration, the apparatus according to this example embodiment can carry out authenticated encryption in which the computational cost is reduced compared with that in the first comparative example even when a cryptographic primitive of which the input length is longer than the output length, such as the one used in the first comparative example, is used. That is, the apparatus according to this example embodiment can efficiently perform an authenticated encryption process even when it uses a cryptographic primitive of which the input length is longer than the output length. That is, the apparatus according to this example embodiment can greatly reduce the data size input to the MAC function according to Poly1305 compared with that in the first comparative example without substantially changing the required number of calls to the random function CC_K.

Note that the apparatus according to this example embodiment uses the MAC function according to Poly1305 in view of the safety when it generates a second tag by using a second plaintext and an excess bit string. That is, in order to securely detect tampering in authenticated encryption, it is necessary to make it difficult to forge a tag when even only one bit of the ciphertext is tampered with. Here, for example, it is assumed that a method similar to the OTR method is adopted for the “detection of tampering of a second ciphertext obtained by an exclusive OR of a second plaintext and a key stream obtained from concatenation of an excess bit string”. That is, it is assumed that a method in which a tag is generated by calculating a checksum by the sum (XOR) of plaintext blocks and encrypting this checksum is adopted. In this case, tampering can be easily performed as described below. That is, a person intending to tamper with the ciphertext or the like can easily make a checksum value thereof equal to the legitimate checksum value thereof by adjusting the difference between the forged ciphertext and the legitimate ciphertext as appropriate. The person intending to tamper with the ciphertext or the like can forge the tag by tampering with the ciphertext as described above. To cope with this, it is possible to secure the safety more reliably by generating a tag by inputting a second ciphertext into a MAC function as described in this example embodiment.

### First Example Embodiment

An example embodiment will be described hereinafter with reference to the drawings. For the sake of clarifying the explanation, the following descriptions and drawings are omitted and simplified as appropriate. Further, the same elements are assigned the same reference numerals (or symbols) throughout the drawings, and redundant descriptions are omitted as appropriate. Note that as described above, an authenticated encryption apparatus according to the first example embodiment corresponds to a configuration in which the cryptographic primitive used in the second comparative example is replaced by the cryptographic primitive used in the first comparative example. Note that in the following description, although the random function CC_K used in the first comparative example is used as the cryptographic primitive in the first example embodiment, the present disclosure is not limited to such a configuration. Any cryptographic primitive of which the output length is longer than the input length can be used as the aforementioned cryptographic primitive.

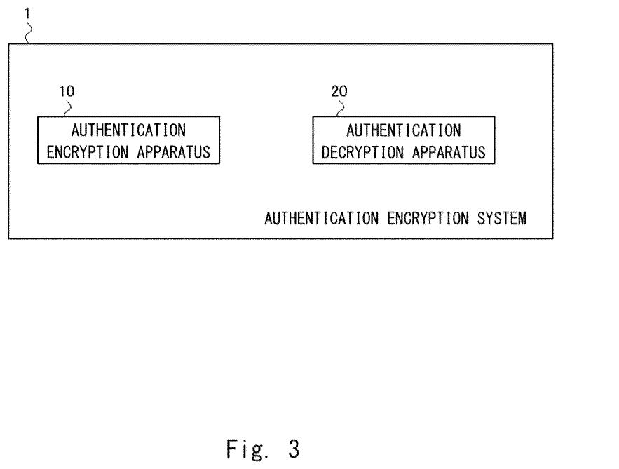

FIG. 3 shows a configuration of an authenticated encryption system 1 according to the present disclosure. The authenticated encryption system 1 includes an authenticated encryption apparatus 10 and an authenticated decryption apparatus 20. The authenticated encryption apparatus 10 and the authenticated decryption apparatus 20 may be physically-integrated one apparatus, or may be apparatuses physically separated from each other. When the authenticated encryption apparatus 10 and the authenticated decryption apparatus 20 are physically separated from each other, the authenticated encryption apparatus 10 and the authenticated decryption apparatus 20 are connected to each other through a wire or wirelessly so that they can communicate with each other. Further, components of the authenticated encryption apparatus 10 (which will be described later) may be implemented in a plurality of apparatuses separated from each other. Similarly, components of the authenticated decryption apparatus 20 (which will be described later) may be implemented in a plurality of apparatuses separated from each other. Further, the authenticated encryption apparatus 10 corresponds to Alice in the above-described example of communication between Alice and Bob, and the authenticated decryption apparatus 20 corresponds to Bob in the above-described example. That is, communication is performed between the authenticated encryption apparatus 10 and the authenticated decryption apparatus 20.

### <Authenticated Encryption Apparatus>

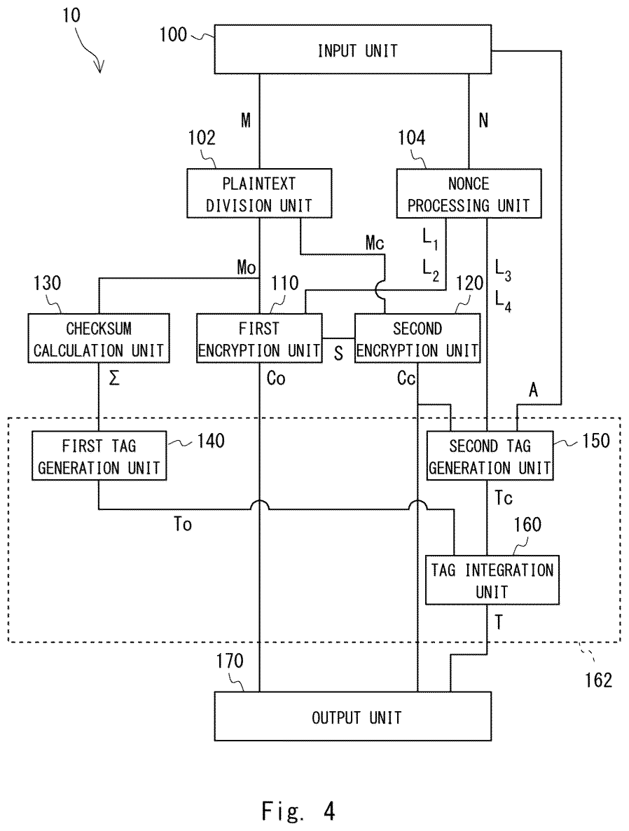

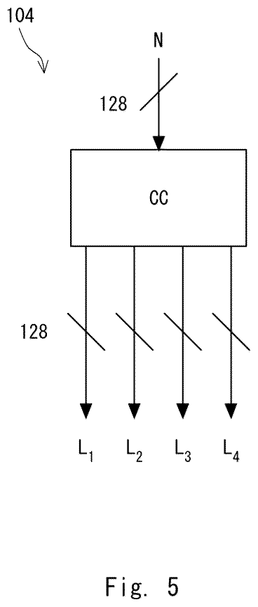

FIG. 4 shows a configuration of an authenticated encryption apparatus 10 according to the present disclosure. Further, FIGS. 5 to 10 show an outline of operations in an authenticated encryption process performed by the authenticated encryption apparatus 10 according to the present disclosure. As shown in FIG. 4, the authenticated encryption apparatus 10 includes an input unit 100, a plaintext division unit 102, and a nonce processing unit 104. Further, the authenticated encryption apparatus 10 according to the first example embodiment includes a first encryption unit 110, a second encryption unit 120, a checksum calculation unit 130, a first tag generation unit 140, a second tag generation unit 150, a tag integration unit 160, and an output unit 170. Further, the first tag generation unit 140, the second tag generation unit 150, and the tag integration unit 160 constitute an authentication tag generation unit 162. That is, the authenticated encryption apparatus 10 includes the authentication tag generation unit 162.

The authenticated encryption apparatus 10 can be implemented, for example, by an information processing apparatus such as a computer. That is, the authenticated encryption apparatus 10 includes a calculation apparatus such as a CPU (Central Processing Unit) and a storage device such as a memory or a disk. The authenticated encryption apparatus 10 implements each of the above-described components, for example, by having the calculation apparatus execute a program(s) stored in the storage device. This feature also applies to other example embodiments described later.

The input unit 100 functions as input means. The plaintext division unit 102 functions as plaintext division means. The nonce processing unit 104 functions as nonce processing means. The first encryption unit 110 functions as first encryption means. The second encryption unit 120 functions as second encryption means. The checksum calculation unit 130 functions as checksum calculation means. The first tag generation unit 140 functions as first tag generation means. The second tag generation unit 150 functions as second tag generation means. The tag integration unit 160 functions as tag integration means (first tag integration means). The authentication tag generation unit 162 functions as authentication tag generation means. The output unit 170 functions as output means.

The input unit 100 receives an input of a nonce N, a plaintext M to be encrypted, and associated data A. The input unit 100 may be implemented, for example, by an input device such as a keyboard. The input unit 100 may receive an input of a nonce N, a plaintext M, and associated data A from, for example, an external apparatus connected thereto through a network. Note that in some cases, there is no associated data A, and in such cases, no associated data A is input.

Note that the input unit 100 may generate a nonce N. In this case, the nonce N is generated in such a manner that the generated nonce does not coincide with any of its past values. That is, the input unit 100 generates a nonce N that is different from any of its past values. Specifically, for example, the input unit 100 first generates an arbitrary fixed value. Further, the input unit 100 records the value of the nonce generated the last time (i.e., immediately before). Then, when the input unit 100 generates a nonce N the second time or later, it outputs a value that is obtained by adding one to the recorded last value. As described above, the input unit 100 may generate a nonce N different from any of the values generated in the past by outputting a value obtained by adding one to the value that was already output immediately before (i.e., output the last time). Note that the input unit 100 may generate a nonce by a method different from the above-described example, provided that it can generate a value different from any of the values generated in the past. Alternatively, another component such as a nonce generation unit may generate the nonce N.

The input unit 100 outputs the plaintext M to the plaintext division unit 102. Further, the input unit 100 outputs the nonce N to the nonce processing unit 104. Further, the input unit 100 outputs the associated data A to the second tag generation unit 150.

The plaintext division unit 102 divides the plaintext M into a first plaintext M_O and a second plaintext M_C at a predetermined ratio. Specifically, the plaintext division unit 102 divides the plaintext M into a first plaintext M_O and a second plaintext M_C so that their lengths are expressed as |M_O|:|M_C|=128:384. That is, the plaintext division unit 102 divides the plaintext M into a first plaintext M_O and a second plaintext M_C based on a ratio between an input length n1 and a length n3 obtained by subtracting the input length n1 from an output length n2. In other words, the plaintext division unit 102 divides the plaintext M into a first plaintext M_O and a second plaintext M_C based on a ratio n1:n3. Note that n1 is the input length of the random function CC_K, which is the cryptographic primitive, and n1 is equal to 128 bits (n1=128). Further, n2 is the output length of the random function CC_K, which is the cryptographic primitive, and n2 is equal to 512 bits (n2=512). Therefore, n3 is equal to 384 bits (n3=512−128=384).

More specifically, the plaintext division unit 102 divides the plaintext M into parts each having a length corresponding to the output length of the cryptographic primitive. That is, the plaintext division unit 102 divides the plaintext M into plaintext parts M[1], . . . , and M[m], each of which has 512 bits (n2=512). Note that m is the number of plaintext parts. Note that when the bit length of the plaintext M is not equal to a multiple of 512, |M[m]| is smaller than 512 (|M[m]|<512).

The plaintext division unit 102 divides, for each of the indexes i=1, . . . , and m, the 512-bit plaintext part M[i] into a 128-bit plaintext block M_O[i] and a 384-bit plaintext block M_C[i]. That is, the plaintext division unit 102 divides the plaintext part M[i] into a plaintext block M_O[i] consisting of n1 bits and a plaintext block M_C[i] consisting of n3 bits. In this way, the plaintext division unit 102 acquires a first plaintext M_O which is expressed as M_O=M_O[1]∥M_O[2]∥ . . . ∥M_O[m]. Further, the plaintext division unit 102 acquires a second plaintext M_C which is expressed as M_C=M_C[1]∥M_C[2]∥ . . . ∥M_C[m]. Note that the symbol “∥” represents concatenation of bit strings. When |M[m]| is equal to 512 (|M[m]|=512), they are expressed as |M_O|:|M_C|=128:384. Note that as will be described later, the first plaintext M_O is processed by the OTR method in which the cryptographic primitive is the random function CC_K. Further, the second plaintext M_C is processed by the ChaCha20-Polyl305 method. The plaintext division unit 102 outputs the first plaintext M_O to the first encryption unit 110. Further, the plaintext division unit 102 outputs the second plaintext M_C to the second encryption unit 120.

Note that when a relation 128<|M[m]|<512 holds, the plaintext division unit 102 may divide the plaintext M[m] into M_O[m] consisting of 128 bits and M_C[m] consisting of less than 384 bits. Further, when |M[m]| is equal to or less than 128 (|M[m]|≤128), the plaintext division unit 102 may divide the plaintext M[m] into M_O[m] consisting of less than 128 bits and M_C[m] consisting of 0 bits. That is, when |M[m]| is equal to or less than 128 (|M[m]|≤128), the plaintext division unit 102 may use the plaintext M[m] itself as M_O[m].

The nonce processing unit 104 processes the nonce N by using the random function CC_K. Specifically, as shown in FIG. 5, the nonce processing unit 104 inputs the 128-bit nonce N to the random function CC_K and acquires a bit string (random number) consisting of 512 bits output therefrom. Further, the nonce processing unit 104 divides the bit string consisting of 512 bits into bit strings L_1, L_2, L_3 and L_4 each consisting of 128 bits (=n1). Then, the nonce processing unit 104 outputs the bit strings L_1 and L_2 to the first encryption unit 110. Further, the nonce processing unit 104 outputs the bit strings L_3 and L_4 to the second tag generation unit 150. Note that the bit strings L_1 and L_2 (first values) are used to acquire a mask value that is used in the encryption process of the first plaintext M_O. Further, the bit strings L_3 and L_4 (second values) are used as keys that are used when a second tag T_C corresponding to the second plaintext M_C is generated. That is, the bit strings L_3 and L_4 correspond to the above-described keys R and S.

The first encryption unit 110 encrypts the first plaintext M_O by the OTR method by using the random function CC_K. In this process, the first encryption unit 110 encrypts the plaintext blocks M_O[1], . . . , and M_O[m], which are obtained by dividing the first plaintext M_O, by using the mask value obtained based on the bit strings L_1 and L_2. That is, the first encryption unit 110 acquires a first ciphertext C_O by the random function CC_K by using the mask value obtained based on the values L_1 and L_2 obtained by encrypting the nonce N using the random function CC_K and the plurality of plaintext blocks M_O[i], respectively. Further, the first encryption unit 110 acquires a first ciphertext C_O by using an exclusive OR of, among the encryption results output from the random function CC_K (encryption function), a first random number consisting of a number of bits corresponding to the input length and the plaintext block. Note that the first ciphertext C_O corresponds to a value in which the first plaintext M_O is encrypted. Further, as described above, the plurality of plaintext blocks M_O[i] are obtained by dividing the first plaintext M_O into blocks each having a length corresponding to the input length of the random function CC_K.

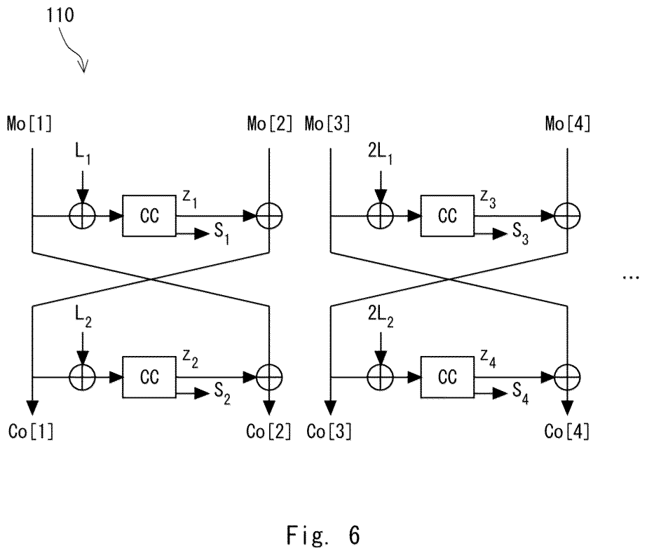

Specifically, as shown in FIG. 6, the first encryption unit 110 encrypts, by the two-stage Feistel structure, each of a pair of a plaintext block M_O[2j−1] and a plaintext block M_O[2j]. Note that the plaintext block M_O[2j−1] is an odd-numbered plaintext block in the plaintext blocks M_O[1], . . . , and M_O[m]. Further, the plaintext block M_O[2j] is an even-numbered plaintext block following the plaintext block M_O[2j−1]. Note that j is an integer between 1 and 1 (inclusive). Further, when m is an even number, 1 is expressed as 1=m/2, whereas when m is an odd number, 1 is expressed as 1=(m+1)/2. As will be described later, the first encryption unit 110 acquires a first ciphertext C_O by using an exclusive OR of, among the encryption results output from the random function CC_K (encryption function), the first random number consisting of a number of bits corresponding to the input length n1 and the plaintext block M_O[i]. Note that the first random number corresponds to a random number z_i described later.

The first encryption unit 110 inputs an exclusive OR of a 128-bit plaintext block M_O[1] and a 128-bit mask value L_1 to the random function CC_K. In this way, the first encryption unit 110 acquires an encryption result CC_K(L_1, M_O[1]) consisting of 512 bits (=n2). Then, the first encryption unit 110 divides the encryption result CC_K(L_1, M_O[1]) into a random number z_1 consisting of 128 bits (=n1) and a random number S_1 consisting of 384 bits (=n3). For example, the first encryption unit 110 may use the upper 128 bits of the encryption result CC_K(L_1, M_O[1]) as the random number z_1 and the lower 384 bits thereof as the random number S_1. This feature also applies to the other plaintext blocks M_O[i] other than the plaintext block M_O[1]. Note that the random number S_1 corresponds to the above-described excess bit string.

Then, the first encryption unit 110 acquires an exclusive OR of the random number z_1 and a plaintext block M_O[2] as a ciphertext block C_O[1] corresponding to the plaintext block M_O[1]. Further, the first encryption unit 110 inputs an exclusive OR of the ciphertext block C_O[1] and a mask value L_2 to the random function CC_K, and thereby acquires an encryption result CC_K(L_2, C_O[1]). Then, the first encryption unit 110 divides the encryption result CC_K(L_2, C_O[1]) into a random number z_2 consisting of 128 bits (=n1) and a random number S_2 consisting of 384 bits (=n3). Then, the first encryption unit 110 acquires an exclusive OR of the random number z_2 and the plaintext block M_O[1] as a ciphertext block C_O[2] corresponding to the plaintext block M_O[2]. Note that the random number S_2 corresponds to the above-described excess bit string.

Further, the first encryption unit 110 inputs an exclusive OR of a 128-bit plaintext block M_O[3] and a 128-bit mask value 2·L_1 to the random function CC_K. In this way, the first encryption unit 110 acquires an encryption result CC_K(2·L_1, M_O[3]) consisting of 512 bits. Then, the first encryption unit 110 divides the encryption result CC_K(2·L_1, M_O[3]) into a random number z_3 consisting of 128 bits (=n1) and a random number S_3 consisting of 384 bits (=n3). Note that the random number S_3 corresponds to the above-described excess bit string.

Then, the first encryption unit 110 acquires an exclusive OR of the random number z_3 and a plaintext block M_O[4] as a ciphertext block C_O[3] corresponding to the plaintext block M_O[3]. Further, the first encryption unit 110 inputs an exclusive OR of the ciphertext block C_O[3] and a mask values 2·L_2 to the random function CC_K, and thereby acquires an encryption result CC_K(2·L_2, C_O[3]). Then, the first encryption unit 110 divides the encryption result CC_K(2·L_2, C_O[3]) into a random number z_4 consisting of 128 bits (=n1) and a random number S_4 consisting of 384 bits (=n3). Then, the first encryption unit 110 acquires an exclusive OR of the random number z_4 and a plaintext block M_O[3] as a ciphertext block C_O[4] corresponding to the plaintext block M_O[4]. Note that the random number S_4 corresponds to the above-described excess bit string.

After that, similarly, the first encryption unit 110 inputs an exclusive OR of a 128-bit plaintext block M_O[2j−1] and a 128-bit mask value 2\hat{ }(j−1)·L_1 to the random function CC_K. In this way, the first encryption unit 110 acquires an encryption result CC_K(2\hat{ }(j−1)·L_1, M_O[2j−1]) consisting of 512 bits. Then, the first encryption unit 110 divides the encryption result CC_K(2\hat{ }(j−1)·L_1, M_O[2j−1]) into a random number z_(2j−1) consisting of 128 bits (=n1) and a random number S_(2j−1) consisting of 384 bits (=n3). Note that the random number S_(2j−1) corresponds to the above-described excess bit string.

Then, the first encryption unit 110 acquires an exclusive OR of the random number z_(2j−1) and a plaintext block M_O[2j] as a ciphertext block C_O[2j−1] corresponding to the plaintext block M_O[2j−1]. Further, the first encryption unit 110 inputs an exclusive OR of the ciphertext block C_O[2j−1] and a mask value 2\hat{ }(j−1)·L_2 to the random function CC_K, and thereby acquires an encryption result CC_K(2\hat{ }(j−1)·L_2, C_O[2j−1]). Then, the first encryption unit 110 divides the encryption result CC_K(2\hat{ }(j−1)·L_2, C_O[2j−1]) into a random number z_(2j) consisting of 128 bits (=n1) and a random number S_(2j) consisting of 384 bits (=n3). Then, the first encryption unit 110 acquires an exclusive OR of the random number z_(2j) and the plaintext block M_O[2j−1] as a ciphertext block C_O[2j] corresponding to the plaintext block M_O[2j]. Note that the random number S_(2j) corresponds to the above-described excess bit string.

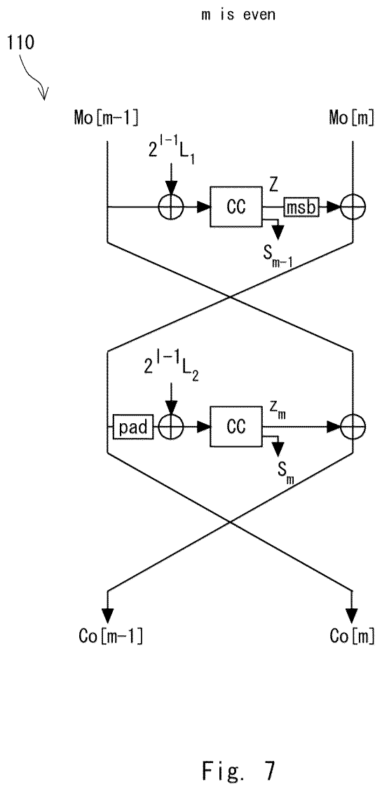

Note that the processing for the last plaintext block is changed according to whether m is an odd number or an even number. When m is an even number, the first encryption unit 110 performs a process like the one shown in FIG. 7. The first encryption unit 110 inputs an exclusive OR of a plaintext block M_O[m−1] consisting of 128 bits (=n1) and a mask value 2\hat{ }(l−1) L_1 consisting of 128 bits (=n1) to the random function CC_K. In this way, the first encryption unit 110 acquires an encryption result CC_K(2\hat{ }(l−1)·L_1, M_O[m−1]) consisting of 512 bits (=n2). Then, the first encryption unit 110 divides the encryption result CC_K(2\hat{ }(l−1)·L_1, M_O[m−1]) into a random number z_(m−1) consisting of 128 bits (=n1) and a random number S_(m−1) consisting of 384 bits (=n3). Note that Z is expressed as Z=z_(m−1). Note that the random number S_(m−1) corresponds to the above-described excess bit string.

Then, the first encryption unit 110 acquires msb{|M_O[m]|} (Z) obtained by truncating the random number Z so that it has a bit length equal to the bit length x (1≤x≤n1 (=128)) of the plaintext block M_O[m]. Then, the first encryption unit 110 acquires an exclusive OR of msb{|M_O[m]|} (Z) and a plaintext block M_O[m] as a ciphertext block C_O[m] corresponding to the plaintext block M_O[m]. Note that the number of bits of the ciphertext block C_O[m] is equal to the number of bits of the plaintext block M_O[m].

Further, the first encryption unit 110 performs a padding process such as a one-zero padding process on the ciphertext block C_O[m], and thereby acquires a bit string pad (C_O[m]) consisting of 128 bits (=n1) corresponding to the ciphertext block C_O[m]. Further, the first encryption unit 110 inputs an exclusive OR of the bit string pad (C_O[m]) and a mask value 2\hat{ }(l−1)·L_2 to the random function CC_K, and thereby acquires an encryption result CC_K(2\hat{ }(l−1)·L_2, pad (C_O[m])). Then, the first encryption unit 110 divides the encryption result CC_K(2\hat{ }(l−1)·L_2, pad (C_O[m])) into a random number z_m consisting of 128 bits (=n1) and a random number S_m consisting of 384 bits (=n3). Then, the first encryption unit 110 acquires an exclusive OR of the random number z_m and a plaintext block M_O[m−1] as a ciphertext block C_[m−1] corresponding to the plaintext block M_O[m−1]. Note that the random number S_m corresponds to the above-described excess bit string.

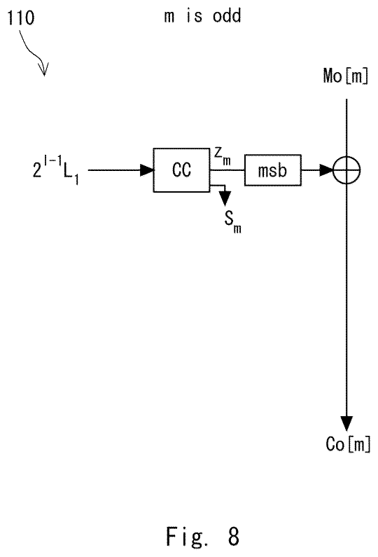

When m is an odd number, the first encryption unit 110 performs a process like the one shown in FIG. 8. The first encryption unit 110 inputs the mask value 2\hat{ }(l−1)·L_1 to the random function CC_K, and thereby acquires an encryption result CC_K(2\hat{ }(l−1)·L_1). Then, the first encryption unit 110 divides the encryption result CC_K(2\hat{ }(l−1)·L_1) into a random number z_m consisting of 128 bits (=n1) and a random number S_m consisting of 384 bits (=n3). Then, the first encryption unit 110 acquires msb{|M_O[m]|} (z_m) obtained by truncating the random number z_m so that it has a bit length equal to the bit length x (1≤x≤n1 (=128)) of the plaintext block M_O[m]. Then, the first encryption unit 110 acquires an exclusive OR of msb{|M_O[m]|} (z_m) and a plaintext block M_O[m] as a ciphertext block C_O[m] corresponding to the plaintext block M_O[m]. Note that the number of bits of the ciphertext block C_O[m] is equal to the number of bits of the plaintext block M_O[m].

The first encryption unit 110 outputs the ciphertext blocks C_O[1], . . . , and C_O[m] to the output unit 170 as a first ciphertext C_O. Note that the first encryption unit 110 may output a ciphertext C_O (=C_O[1]∥ . . . ∥C_O[m]) obtained by concatenating the ciphertext blocks C_O[1], . . . , and C_O[m] to the output unit 170.

Further, the first encryption unit 110 acquires a random number S consisting of 384×m bits by concatenating the random numbers S_1, S_2, . . . and S_m corresponding to the excess bit strings. That is, S is expressed as S=S_1∥S_2∥ . . . ∥S_m. Note that strictly speaking, the relation |S|=384×m holds only when |M| is equal to 512×m (|M|=512×m). Then, the first encryption unit 110 outputs the random number S to the second encryption unit 120. Note that the first encryption unit 110 may output the random numbers S_1, S_2, . . . , and S_m to the second encryption unit 120 without concatenating them. In this case, the second encryption unit 120 may concatenate the random numbers S_1, S_2, . . . , and S_m, and thereby acquire the random number S consisting of 384×m bits (=n3×m).

Note that among the encryption results output from the random function CC_K, which is the encryption function in the encryption of the first plaintext M_O, values z_1, . . . , and z_m are used for the encryption of the first plaintext M_O. Meanwhile, among the encryption results output from the random function CC_K, the random numbers S_1, S_2, . . . , and S_m (random number S) are values other than those used for the encryption of the first plaintext M_O.

The checksum calculation unit 130 calculates a checksum Σ based on an exclusive OR of some of the plurality of plaintext blocks M_O[i]. Specifically, the checksum calculation unit 130 calculates a checksum Σ by calculating an exclusive OR of even-numbered plaintext blocks M_O[2], M_O[4], . . . . More specifically, when m is an even number, the checksum calculation unit 130 calculates a checksum Σ consisting of 128 bits (=n1) as expressed by the below-shown Expression 5.

$$[ Expression 5 ]$$

$$Σ = {M}_{o} [ 2 ] ⊕ {M}_{o} [ 4 ] ⊕ ⋯ ⊕ {M}_{o} [ m - 2 ] ⊕ Z ⊕ pad ( {C}_{o} [ m ] ) \qquad ( 5 )$$

On the other hand, when m is an odd number, the checksum calculation unit 130 calculates a checksum Σ consisting of 128 bit (=n1) as expressed by the below-shown Expression 6.

$$[ Expression 6 ]$$

$$Σ = {M}_{o} [ 2 ] ⊕ {M}_{o} [ 4 ] ⊕ ⋯ ⊕ {M}_{o} [ m - 1 ] ⊕ pad ( {M}_{o} [ m ] ) \qquad ( 6 )$$

Note that when the checksum calculation unit 130 performs a one-zero padding process on C_O[m], pad(C_O[m]) in Expression 5 can be expressed as ozp(C_O[m]). Similarly, when the checksum calculation unit 130 performs a one-zero padding process on M_O[m], pad(M_O[m]) in Expression 6 may be expressed as ozp(M_O[m]). The same applies to other pad( ). The checksum calculation unit 130 outputs the obtained checksum Σ to the first tag generation unit 140.

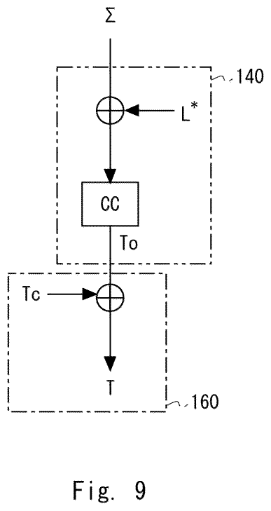

The first tag generation unit 140 of the authentication tag generation unit 162 generates a first tag T_O for generating an authentication tag. The first tag generation unit 140 generates a first tag T_O by the OTR method by using the checksum Σ. Specifically, as shown in FIG. 9, the first tag generation unit 140 generates a first tag T_O (first partial tag) by the random function CC_K, which is the encryption function, by using the checksum Σ and an appropriate mask value L\hat{ }*. Note that the mask value L\hat{ }* is obtained based on the bit strings L_1 and L_2 as described later. That is, the first tag generation unit 140 generates a first tag T_O by the encryption function by using a value (checksum Σ) obtained based on the exclusive OR of some of a plurality of plaintext blocks and a mask value L\hat{ }* obtained based on the bit strings L_1 and L_2 (first values).

More specifically, the first tag generation unit 140 generates a first tag T_O consisting of 128 bits (=n1) by the random function CC_K by using the exclusive OR of a checksum Σ consisting of 128 bits (=n1) and a mask value L\hat{ }* consisting of 128 bits (=n1). The first tag generation unit 140 acquires the encryption result obtained by inputting the exclusive OR of the checksum Σ and the mask value L\hat{ }* to the random function CC_K as the first tag T_O. The first tag generation unit 140 outputs the generated first tag T_O to the tag integration unit 160.

Note that when m is an even number and |M[m]| is equal to n1 (|M[m]|=n1) (=128 bits), L\hat{ }* may be expressed as L\hat{ }*=3·2\hat{ }(l−1)·L_2. Further, when m is an even number and |M[m]| is not equal to n1 (|M[m]|≠n1), L\hat{ }* may be expressed as L\hat{ }*=3\hat{ }2·2\hat{ }(l−1)·L_2. Further, when m is an odd number and |M[m]| is equal to n1 (|M[m]|=n1), L\hat{ }* may be expressed as L\hat{ }*=3·2\hat{ }(l−1)·L_1. Further, when m is an odd number and |M[m]| is not equal to n1 (|M[m]|≠n1), L\hat{ }* may be expressed as L\hat{ }*=3\hat{ }2·2\hat{ }(l−1)·L_1. Note that although the mask value L\hat{ }* is obtained by using triple calculation in the above-described example, but the method obtaining the mask value L\hat{ }* is not limited to this example. For example, the mask value L\hat{ }* may be obtained by using septuple calculation.

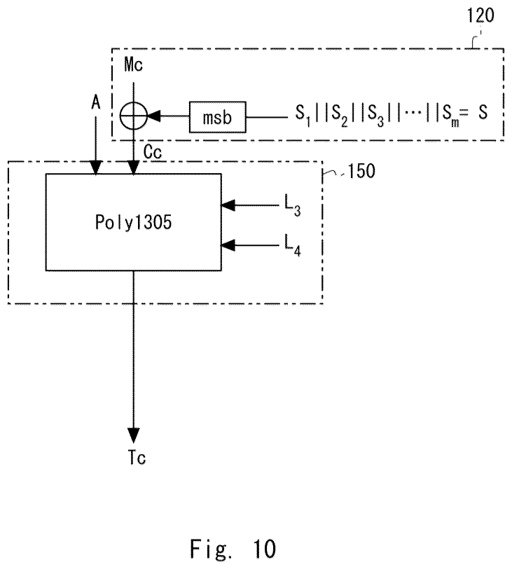

The second encryption unit 120 encrypts the second plaintext M_C by the ChaCha20-Polyl305 method (CP method). Specifically, as shown in FIG. 10, the second encryption unit 120 encrypts the plaintext M_C by using the random number S as a key stream. As a result, the second encryption unit 120 acquires a second ciphertext C_C in which the second plaintext M_C is encrypted. That is, the second encryption unit 120 acquires the second ciphertext C_C in which the second plaintext M_C is encrypted by using the random numbers S (second random numbers) and the second plaintext M_C. Note that as described above, the random number S (S_1, S_2, . . . ) is, among the encryption results output from the random function CC_K (encryption function) in the encryption of the first plaintext M_O, a value other than the values (random number z; first random number) used for the encryption of the first plaintext M_O.

More specifically, the second encryption unit 120 acquires a second ciphertext C_C by using an exclusive OR of a value (random number S) obtained by concatenating the random numbers S_1, S_2, . . . , and S_m (second random numbers) and the second plaintext M_C. That is, the second encryption unit 120 acquires msb{|M_C|}(S) obtained by truncating the random number S (=S_1∥S_2∥ . . . ∥S_m) so that it has a number of bits equal to the number of bits of the second plaintext M_C. Then, the second encryption unit 120 acquires an exclusive OR of msb{|M_C|}(S) and the second plaintext M_C as a second ciphertext C_C corresponding to the second plaintext M_C. The second encryption unit 120 outputs the second ciphertext C_C to the second tag generation unit 150 and the output unit 170.

The second tag generation unit 150 of the authentication tag generation unit 162 generates a second tag T_C for generating an authentication tag. The second tag generation unit 150 generates the second tag T_C by the CP method by using the second ciphertext C_C. Specifically, as shown in FIG. 10, the second tag generation unit 150 generates the second tag T_C by using bit strings L_3 and L_4 (second values) obtained by encrypting the nonce N using the random function CC_K and the second ciphertext C_C. More specifically, the second tag generation unit 150 generates the second tag T_C by a function by a message authentication code (MAC function) by using the bit strings L_3 and L_4 (second values) and the second ciphertext C_C. In this process, as described above, the second tag generation unit 150 uses the bit strings L_3 and L_4 each consisting of 128 bits (=n1) as keys corresponding to the keys R and S, respectively.

The second tag generation unit 150 inputs the second ciphertext C_C, the associated data A, and the keys L_3 and L_4 to the MAC function according to Poly1305 used in the CP method. In this way, the second tag generation unit 150 acquires a bit string consisting of 128 bits output from the MAC function as a second tag T_C. Note that when there is no associated data A, no associated data A is input to the MAC function. The second tag generation unit 150 outputs the second tag T_C to the tag integration unit 160. Note that although the tag generation unit 76 generates a tag T by calculating the sum, in mod (2\hat{ }128), of the output H_R of the polynomial hash function and the key S in the first comparative example, the present disclosure is not limited to such a configuration. The second tag generation unit 150 may generate the tag by calculating the sum, in any group, of the output H_L₃ of the polynomial hash function, which is defined by the key L_3, and the key L_4. This also applies to the authenticated decryption apparatus 20 and other example embodiments described later.

The authentication tag generation unit 162 generates an authentication tag T. The tag integration unit 160 integrates (i.e., combines) the first and second tags T_O and T_C, and thereby generates one authentication tag T. Specifically, as shown in FIG. 9, the tag integration unit 160 acquires an exclusive OR of the first and second tags T_O and T_C as the authentication tag T. That is, the authentication tag generation unit 162 generates the first tag T_O, generates the second tag T_C, and generates the authentication tag T. The authentication tag generation unit 162 (tag integration unit 160) outputs the authentication tag T to the output unit 170.

The output unit 170 performs control for outputting the ciphertext C and the authentication tag T. Note that the output unit 170 may generate a ciphertext C corresponding to the plaintext M by using the first and second ciphertexts C_O and C_C as follows. That is, the output unit 170 divides the second ciphertext C_C into ciphertext blocks C_C[1], . . . , and C_C[m] each consisting of 384 bits (=n3). Note that the number of bits of the ciphertext block C_C[m] is equal to the number of bits of the plaintext block M_C[m]. Further, the output unit 170 concatenates, for each of the indexes i=1, . . . , and m, the ciphertext block C_O[i] consisting of 128 bits (=n1) and the ciphertext block C_C[i] consisting of 384 bits (=n3), and thereby acquires a ciphertext part C[i] consisting of 512 bits (=n2). That is, C[i] is equal to C_O[i]∥C_C[i] (C[i]=C_O[i]∥C_C[i]). Note that the number of bits of C[m] is equal to the number of bits of M[m]. Then, the output unit 170 acquires a ciphertext C by concatenating the ciphertext parts C[1], . . . , and C[m]. That is, C is equal to C[1]∥ . . . ∥C[m] (C=C[1]∥ . . . ∥C[m]).

The output unit 170 may, for example, perform control so as to make an output device such as a display device display the ciphertext C and the authentication tag T. Further, the output unit 170 may, for example, perform control so as to make an external apparatus connected thereto through a network output the ciphertext C and the authentication tag T. Further, the output unit 170 may perform control so as to output the nonce N and the associated data A. For example, the output unit 170 transmits (N, A, C, T) to the authenticated decryption apparatus 20.

### <Authenticated Decryption Apparatus>

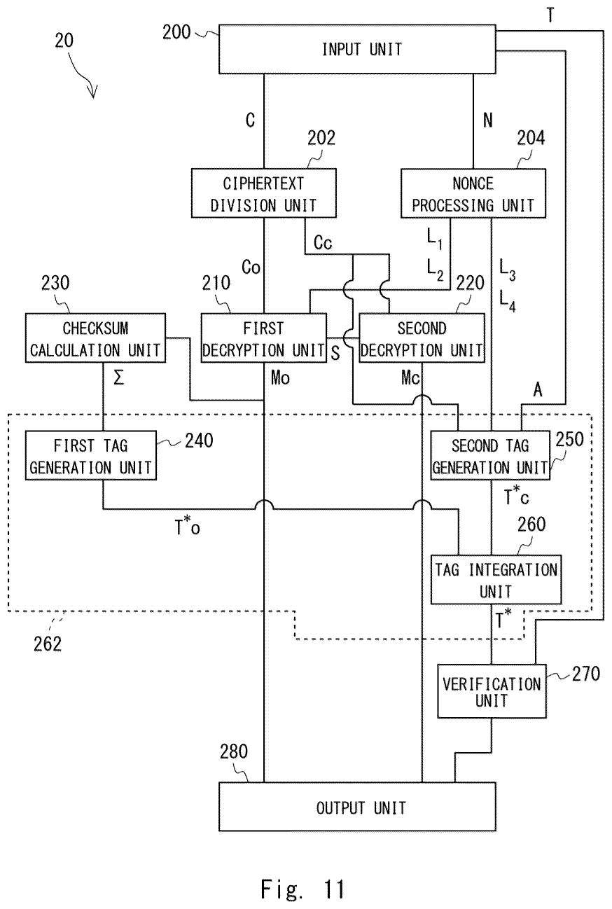

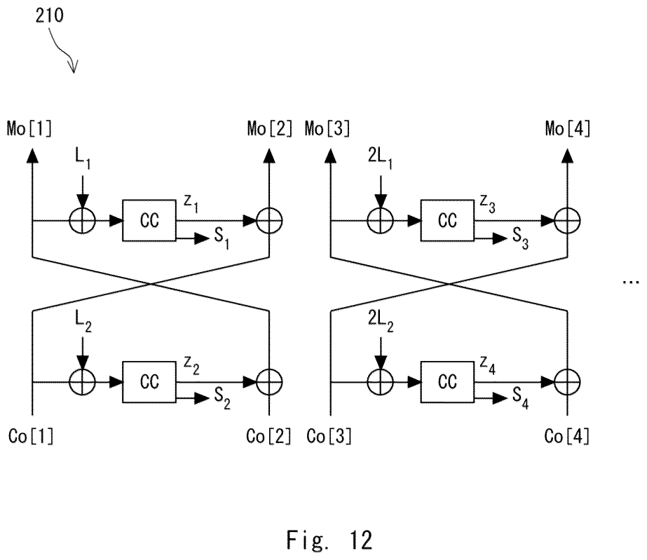

FIG. 11 shows a configuration of the authenticated decryption apparatus 20 according to the present disclosure. Further, FIGS. 12 to 16 show an outline of operations in an authenticated decryption process performed by the authenticated decryption apparatus 20 according to the present disclosure. As shown in FIG. 11, the authenticated decryption apparatus 20 includes an input unit 200, a ciphertext division unit 202, and a nonce processing unit 204. Further, the authenticated decryption apparatus 20 according to the first example embodiment includes a first decryption unit 210, a second decryption unit 220, a checksum calculation unit 230, a first tag generation unit 240, a second tag generation unit 250, a tag integration unit 260, a verification unit 270, and an output unit 280. Further, the first tag generation unit 240, the second tag generation unit 250, and the tag integration unit 260 constitute a verification tag generation unit 262. That is, the authenticated decryption apparatus 20 includes the verification tag generation unit 262.

The authenticated decryption apparatus 20 can be implemented, for example, by an information processing apparatus such as a computer. That is, the authenticated decryption apparatus 20 includes a calculation apparatus such as a CPU and a storage device such as a memory or a disk. The authenticated decryption apparatus 20 implements each of the above-described components, for example, by having a calculation apparatus execute a program(s) stored in the storage device. This feature also applies to other example embodiments described later.

The input unit 200 functions as input means. The ciphertext division unit 202 functions as ciphertext division means. The nonce processing unit 204 functions as nonce processing means. The first decryption unit 210 functions as first decryption means. The second decryption unit 220 functions as second decryption means. The checksum calculation unit 230 functions as checksum calculation means. The first tag generation unit 240 functions as first tag generation means (third tag generation means). The second tag generation unit 250 functions as second tag generation means (fourth tag generation means). The tag integration unit 260 functions as tag integration means (second tag integration means). The verification tag generation unit 262 functions as verification tag generation means. The verification unit 270 functions as verification means. The output unit 280 functions as output means.

The input unit 200 receives an input of a nonce N, associated data A, a ciphertext C to be decrypted, and an authentication tag T transmitted from the authenticated encryption apparatus 10. The input unit 200 may be implemented, for example, by an input device such as a keyboard. The input unit 200 may receive an input of a nonce N, associated data A, a ciphertext C, and an authentication tag T from, for example, an external apparatus connected thereto through a network. Note that in some cases, there is no associated data A, and in such cases, no associated data A is input.

The input unit 200 outputs the ciphertext C to the ciphertext division unit 202. The input unit 200 outputs the nonce N to the nonce processing unit 204. Further, the input unit 200 outputs the associated data A to the second tag generation unit 250. Further, the input unit 200 outputs the authentication tag T to the verification unit 270.

The ciphertext division unit 202 divides the ciphertext C by substantially the same method as the method by which the plaintext division unit 102 divides the plaintext M. The ciphertext division unit 202 divides the ciphertext C into a first ciphertext C_O and a second ciphertext C_C at a predetermined ratio. Specifically, the ciphertext division unit 202 divides the ciphertext C into a first ciphertext C_O and a second ciphertext C_C so that their lengths are expressed as |C_O|:|C_C|=128:384. That is, the ciphertext division unit 202 divides the ciphertext C into a first ciphertext C_O and a second ciphertext C_C based on a ratio between an input length n1 and a length n3 obtained by subtracting the input length n1 from an output length n2. In other words, the ciphertext division unit 202 divides the ciphertext C into a first ciphertext C_O and a second ciphertext C_C based on a ratio n1:n3.

More specifically, the ciphertext division unit 202 divides the ciphertext C into parts each having a length corresponding to the output length of the cryptographic primitive. That is, the ciphertext division unit 202 divides the ciphertext C into ciphertext parts C[1], . . . , and C[m], each of which has 512 bits (n2=512). Note that m is the number of ciphertext parts. Note that when the bit length of ciphertext C is not equal to a multiple of 512, |C[m]| is smaller than 512 (|M[m]|<512).

The ciphertext division unit 202 divides, for each of the indexes i=1, . . . , and m, the ciphertext part C[i] into a 128-bit ciphertext block C_O[i] and a 384-bit ciphertext block C_C[i]. That is, the ciphertext division unit 202 divides the ciphertext part C[i] into a ciphertext block C_O[i] consisting of n1 bits and a ciphertext block C_C[i] consisting of n3 bits. In this way, the ciphertext division unit 202 acquires a first ciphertext C_O where C_O=C_O[1]∥C_O[2]∥ . . . ∥C_O[m]. Further, the ciphertext division unit 202 acquires a second ciphertext C_C where C_C=C_C[1]∥C_C[2]∥ . . . ∥C_C[m]. When |C[m]| is 512 (|C[m]|=512), they are expressed as |C_O|:|C_C|=128:384. Note that as will be described later, the first ciphertext C_O is processed by the OTR method in which the cryptographic primitive is the random function CC_K. Further, the second ciphertext C_C is processed by the ChaCha20-Poly1305 method. The ciphertext division unit 202 outputs the first ciphertext C_O to the first decryption unit 210. The ciphertext division unit 202 outputs the second ciphertext C_C to the second decryption unit 220 and the second tag generation unit 250.

Note that when relations 128<|C[m]|<512 hold, the ciphertext division unit 202 may divide the ciphertext C[m] into C_O[m] consisting of 128 bits and C_C[m] consisting of less than 384 bits. Further, when |C[m]| is equal to or less than 128 (|C[m]|≤128), the ciphertext division unit 202 may divide the ciphertext C[m] into C_O[m] consisting of less than 128 bits and C_C[m] consisting of 0 bits. That is, when |C[m]| is equal to or less than 128 (|C[m]|≤128), the ciphertext division unit 202 may use the ciphertext C[m] itself as C_O[m].

The nonce processing unit 204 processes the nonce N by using the random function CC_K by substantially the same method as the method by which the nonce processing unit 104 processes the nonce as shown in FIG. 5. Specifically, the nonce processing unit 204 inputs the 128-bit nonce N to the random function CC_K and acquires a bit string (random number) consisting of 512 bits output from the function. Further, the nonce processing unit 204 divides the bit string consisting of 512 bits into bit strings L_1, L_2, L_3 and L_4 each consisting of 128 bits (=n1). Then, the nonce processing unit 204 outputs the bit strings L_1 and L 2 to the first decryption unit 210. Further, the nonce processing unit 204 outputs the bit strings L_3 and L_4 to the second tag generation unit 250. Note that the bit strings L_1 and L_2 (first values) are used to acquire a mask value that is used in the decryption process of the first ciphertext C_O. Further, the bit strings L_3 and L_4 (second values) are used as keys that are used when a tag T_C corresponding to a second plaintext M_C obtained by decrypting the second ciphertext C_C is generated. That is, the bit strings L_3 and L_4 correspond to the above-described keys R and S.

The first decryption unit 210 processes the first ciphertext C_O by using the random function CC_K by a method corresponding to the method by which the first encryption unit 110 processes the first plaintext M_O. The first decryption unit 210 decrypts the first ciphertext C_O by the OTR method by using the random function CC_K. In this process, the first decryption unit 210 decrypts the ciphertext blocks C_O[1], . . . , and C_O[m], which are obtained by dividing the first ciphertext C_O, by using a mask value obtained based on the bit strings L_1 and L_2. That is, the first decryption unit 210 acquires a first plaintext M_O by the random function CC_K by using the mask value obtained based on the values L_1 and L_2 obtained by encrypting the nonce N using the random function CC_K and the plurality of ciphertext blocks C_O[i], respectively. Further, the first decryption unit 210 acquires a first plaintext M_O by using an exclusive OR of, among the encryption results output from the random function CC_K (encryption function), a first random number consisting of a number of bits corresponding to the input length and the ciphertext block. Note that the first plaintext M_O corresponds to a value obtained by decrypting the first ciphertext C_O. Further, as described above, the plurality of ciphertext blocks C_O[i] are obtained by dividing the first ciphertext C_O into blocks each having a length corresponding to the input length of the random function CC_K.

Specifically, as shown in FIG. 12, the first decryption unit 210 decrypts, by the two-stage Feistel structure, each of a pair of a ciphertext block C_O[2j−1] and a ciphertext block C_O[2j]. Note that the plaintext block C_O[2j−1] is an odd-numbered plaintext block in the plaintext blocks C_O[1], . . . , and C_O[m]. Further, the plaintext block C_O[2j] is an even-numbered plaintext block following the plaintext block C_O[2j−1]. Note that j is an integer between 1 and 1 (inclusive). Further, when m is an even number, 1 is expressed as 1=m/2, whereas when m is an odd number, 1 is expressed as 1=(m+1)/2. As will be described later, the first decryption unit 210 acquires a first plaintext M_O by using an exclusive OR of, among the encryption results output from the random function CC_K (encryption function), the first random number consisting of a number of bits corresponding to the input length n1 and the ciphertext block C_O[i]. Note that the first random number corresponds to a random number z_i described later.

The first decryption unit 210 inputs an exclusive OR of a 128-bit ciphertext block C_O[1] and a 128-bit mask value L_2 to the random function CC_K. In this way, the first decryption unit 210 acquires an encryption result CC_K(L_2, C_O[1]) consisting of 512 bits (=n2). Then, the first decryption unit 210 divides the encryption result CC_K(L_2, C_O[1]) into a random number z_2 consisting of 128 bits (=n1) and a random number S_2 consisting of 384 bits (=n3). For example, the first decryption unit 210 may use the upper 128 bits of the encryption result CC_K(L_2, C_O[1]) as the random number z_2 and the lower 384 bits thereof as the random number S_2. Note that the random number S_2 corresponds to the above-described excess bit string.

Then, the first decryption unit 210 acquires an exclusive OR of the random number z_2 and a ciphertext block C_O[2] as a plaintext block M_O[1] corresponding to the ciphertext block C_O[1]. Further, the first decryption unit 210 inputs an exclusive OR of the plaintext block M_O[1] and a mask value L_1 to the random function CC_K, and thereby acquires an encryption result CC_K(L_1, M_O[1]). Then, the first decryption unit 210 divides the encryption result CC_K(L_1, M_O[1]) into a random number z_1 consisting of 128 bits (=n1) and a random number S_1 consisting of 384 bits (=n3). Then, the first decryption unit 210 acquires an exclusive OR of the random number z_1 and the ciphertext block C_O[1] as a plaintext block M_O[2] corresponding to the ciphertext block C_O[2]. Note that the random number S_1 corresponds to the above-described excess bit string.

Further, the first decryption unit 210 inputs an exclusive OR of a 128-bit ciphertext block C_O[3] and a 128-bit mask value 2·L_2 to the random function CC_K. In this way, the first decryption unit 210 acquires an encryption result CC_K(2·L_2, C_O[3]) consisting of 512 bits. Then, the first decryption unit 210 divides the encryption result CC_K(2·L_2, C_O[3]) into a random number z_4 consisting of 128 bits (=n1) and a random number S_4 consisting of 384 bits (=n3). Note that the random number S_4 corresponds to the above-described excess bit string.

Then, the first decryption unit 210 acquires an exclusive OR of the random number z_4 and a ciphertext block C_O[4] as a plaintext block M_O[3] corresponding to the ciphertext block C_O[3]. Further, the first decryption unit 210 inputs an exclusive OR of the plaintext block M_O[3] and a mask values 2·L_1 to the random function CC_K, and thereby acquires an encryption result CC_K(2·L_1, M_O[3]). Then, the first decryption unit 210 divides the encryption result CC_K(2·L_1, M_O[3]) into a random number z_3 consisting of 128 bits (=n1) and a random number S_3 consisting of 384 bits (=n3). Then, the first decryption unit 210 acquires an exclusive OR of the random number z 3 and a ciphertext block C_O[3] as a plaintext block M_O[4] corresponding to the ciphertext block C_O[4]. Note that the random number S_3 corresponds to the above-described excess bit string.

After that, similarly, the first decryption unit 210 inputs an exclusive OR of a 128-bit ciphertext block C_O[2j−1] and a 128-bit mask value 2\hat{ }(j−1)·L_2 to the random function CC_K. In this way, the first decryption unit 210 acquires an encryption result CC_K(2\hat{ }(j−1)·L_2, C_O[2j−1]) consisting of 512 bits. Then, the first decryption unit 210 divides the encryption result CC_K(2\hat{ }(j−1)·L_2, C_O[2j−1]) into a random number z_(2j) consisting of 128 bits (=n1) and a random number S_(2j) consisting of 384 bits (=n3). Note that the random number S_(2j) corresponds to the above-described excess bit string.

Then, the first decryption unit 210 acquires an exclusive OR of the random number z_(2j) and a ciphertext block C_O[2j] as a plaintext block M_O[2j−1] corresponding to the ciphertext block C_O[2j−1]. Further, the first decryption unit 210 inputs an exclusive OR of the plaintext block M_O[2j−1] and a mask value 2\hat{ }(j−1)·L_1 to the random function CC_K, and thereby acquires an encryption result CC_K(2\hat{ }(j−1)·L_1, M_O[2j−1]). Then, the first decryption unit 210 divides the encryption result CC_K(2\hat{ }(j−1)·L_1, M_O[2j−1]) into a random number z_(2j−1) consisting of 128 bits (=n1) and a random number S_(2j−1) consisting of 384 bits (=n3). Then, the first decryption unit 210 acquires an exclusive OR of the random number z_(2j−1) and a ciphertext block C_O[2j−1] as a plaintext block M_O[2j] corresponding to the ciphertext block C_O[2j]. Note that the random number S_(2j−1) corresponds to the above-described excess bit string.

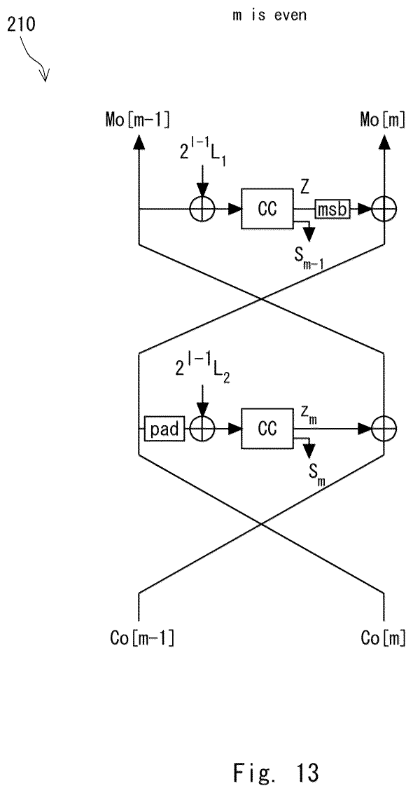

Note that the processing for the last plaintext block is changed according to whether m is an odd number or an even number. When m is an even number, the first decryption unit 210 performs the processing shown in FIG. 13. Further, the first decryption unit 210 performs a padding process such as a one-zero padding process on the ciphertext block C_O[m], and thereby acquires a bit string pad (C_O[m]) consisting of 128 bits (=n1) corresponding to the ciphertext block C_O[m]. Further, the first decryption unit 210 inputs an exclusive OR of the bit string pad (C_O[m]) and a mask value 2\hat{ }(l−1)·L_2 to the random function CC_K, and thereby acquires an encryption result CC_K(2\hat{ }(l−1)·L_2, pad (C_O[m])). Then, the first decryption unit 210 divides the encryption result CC_K(2\hat{ }(l−1)·L_2, pad (C_O[m])) into a random number z_m consisting of 128 bits (=n1) and a random number S_m consisting of 384 bits (=n3). Then, the first decryption unit 210 acquires an exclusive OR of the random number z_m and a ciphertext block C_O[m−1] as a plaintext block M_O[m−1] corresponding to the ciphertext block C_O[m−1]. Note that the random number S_m corresponds to the above-described excess bit string.

Further, the first decryption unit 210 inputs an exclusive OR of a plaintext block M_O[m−1] consisting of 128 bits (=n1) and a mask value 2\hat{ }(l−1)·L_1 consisting of 128 bits (=n1) to the random function CC_K. In this way, the first decryption unit 210 acquires an encryption result CC_K(2\hat{ }(l−1)·L_1, M_O[m−1]) consisting of 512 bits (=n2). Then, the first decryption unit 210 divides the encryption result CC_K(2\hat{ }(l−1)·L_1, M_O[m−1]) into a random number z_(m−1) consisting of 128 bits (=n1) and a random number S_(m−1) consisting of 384 bits (=n3). Note that Z is expressed as Z=z_(m−1). Further, the random number S_(m−1) corresponds to the above-described excess bit string.

Then, the first decryption unit 210 acquires msb{|C_O[m]|} (Z) obtained by truncating the random number Z so that it has a bit length equal to the bit length x (1≤x≤n1 (=128)) of the plaintext block C_O[m]. Then, the first decryption unit 210 acquires an exclusive OR of msb{|C_O[m]|} (Z) and a ciphertext block C_O[m] as a plaintext block M_O[m] corresponding to the ciphertext block C_O[m].

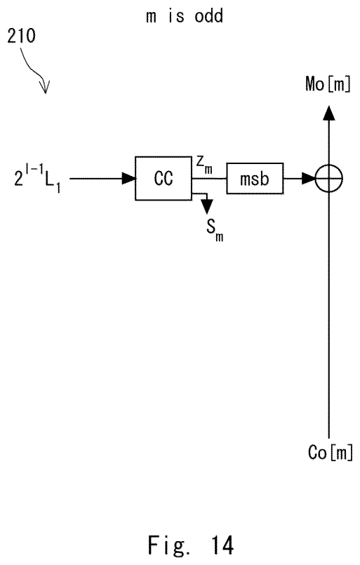

When m is an odd number, the first decryption unit 210 performs a process like the one shown in FIG. 14. The first decryption unit 210 inputs the mask value 2\hat{ }(l−1)·L_1 to the random function CC_K, and thereby acquires an encryption result CC_K(2\hat{ }(l−1)·L_1). Then, the first decryption unit 210 divides the encryption result CC_K(2\hat{ }(l−1)·L_1) into a random number z_m consisting of 128 bits (=n1) and a random number S_m consisting of 384 bits (=n3). Then, the first decryption unit 210 acquires msb{|C_O[m]|} (z_m) obtained by truncating the random number z_m so that it has a bit length equal to the bit length x (1≤x≤n1 (=128)) of the plaintext block C_O[m]. Then, the first encryption unit 110 acquires an exclusive OR of msb{|C_O[m]|} (z_m) and a ciphertext block C_O[m] as a plaintext block M_O[m] corresponding to the ciphertext block C_O[m].

The first decryption unit 210 outputs the plaintext blocks M_O[1], . . . a and M_O[m] to the checksum calculation unit 230 and the output unit 280 as a first plaintext M_O. Note that the first decryption unit 210 may output M_O (=M_O[1]∥ . . . ∥M_O[m]) obtained by concatenating the plaintext blocks M_O[1], . . . , and M_O[m] to the checksum calculation unit 230 and the output unit 280.

Further, the first decryption unit 210 acquires a random number S consisting of 384×m bits by concatenating the random numbers S_1, S_2, . . . , and S_m corresponding to the excess bit strings. That is, S is expressed as S=S_1∥S_2∥ . . . ∥S_m. Note that strictly speaking, the relation |S|=384×m holds only when |C| is equal to 512×m (|C|=512×m). Then, the first decryption unit 210 outputs the random number S to the second decryption unit 220. Note that the first decryption unit 210 may output the random numbers S_1, S_2, . . . , and S_m to the second decryption unit 220 without concatenating them. In this case, the second decryption unit 220 may concatenate the random numbers S_1, S_2, . . . , and S_m, and thereby acquire the random number S consisting of 384×m bits (=n3×m).

Note that among the encryption results output from the random function CC_K, which is the encryption function in the decryption of the first ciphertext C_O, values z_1, . . . , and z_m are used in the decryption of the first ciphertext C_O. Meanwhile, among the encryption results output from the random function CC_K, the random numbers S_1, S_2, . . . , and S_m (random number S) are values other than those used in the decryption of the first ciphertext C_O.

The checksum calculation unit 230 calculates a checksum in substantially the same manner as the above-described checksum calculation unit 130 does. That is, the checksum calculation unit 230 calculates a checksum Σ based on an exclusive OR of some of the plurality of plaintext blocks M_O[i]. Specifically, the checksum calculation unit 230 calculates a checksum Σ by calculating an exclusive OR of even-numbered plaintext blocks M_O[2], M_O[4], . . . . More specifically, when m is an even number, the checksum calculation unit 230 calculates a checksum Σ consisting of 128 bits (=n1) as expressed by the above-shown Expression 5. On the other hand, when m is an odd number, the checksum calculation unit 230 calculates a checksum Σ consisting of 128 bits (=n1) as expressed by the above-shown Expression 6. The checksum calculation unit 230 outputs the obtained checksum Σ to the first tag generation unit 240.

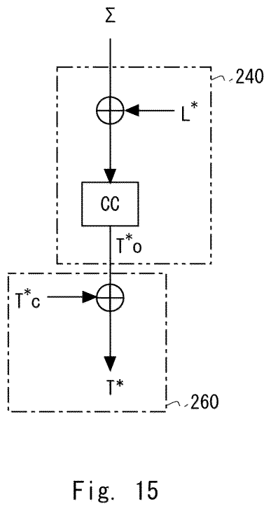

The first tag generation unit 240 of the verification tag generation unit 262 generates a first tag T*_O for generating a verification tag T* in substantially the same manner as the above-described first tag generation unit 140 does. The first tag generation unit 240 generates a first tag T*_O by the OTR method by using the checksum Σ. Specifically, as shown in FIG. 15, the first tag generation unit 240 generates a first tag T*_O (first partial tag) by the random function CC_K, which is the encryption function, by using the checksum Σ and an appropriate mask value L\hat{ }*. Note that the mask value L\hat{ }* is obtained based on the bit strings L_1 and L_2 as described above. That is, the first tag generation unit 240 generates a first tag T*_O by the encryption function by using a value (checksum Σ) obtained based on an exclusive OR of some of a plurality of plaintext blocks and a mask value L\hat{ }* obtained based on the bit strings L_1 and L_2 (first values).

More specifically, the first tag generation unit 240 generates a first tag T*_O consisting of 128 bits (=n1) by the random function CC_K by using an exclusive OR of a checksum Σ consisting of 128 bits (=n1) and a mask value L\hat{ }* consisting of 128 bits (=n1). The first tag generation unit 240 acquires the encryption result obtained by inputting the exclusive OR of the checksum Σ and the mask value L\hat{ }* to the random function CC_K as the first tag T*_O. The first tag generation unit 240 outputs the generated first tag T*_O to the tag integration unit 260.

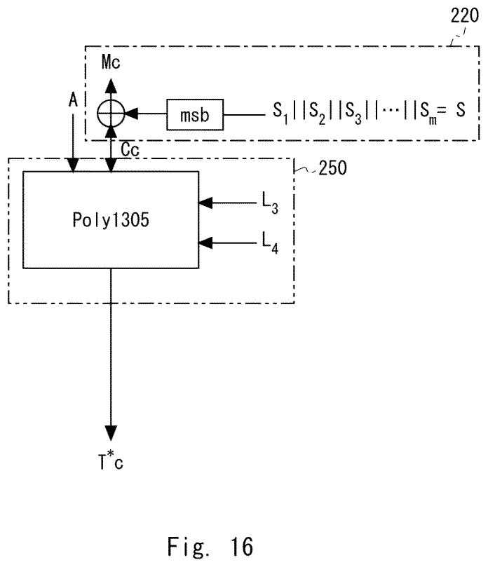

The second decryption unit 220 processes the second ciphertext C_C by a method corresponding to the method by which the second encryption unit 120 processes the second plaintext M_C. The second decryption unit 220 decrypts the second ciphertext C_C by the ChaCha20-Poly1305 method (CP method). Specifically, as shown in FIG. 16, the second decryption unit 220 decrypts the ciphertext C_C by using the random number S as a key stream. As a result, the second decryption unit 220 acquires a second plaintext M_C obtained by decrypting the second ciphertext C_C. That is, the second decryption unit 220 acquires the second plaintext M_C obtained by decrypting the second ciphertext C_C by using the random number S (second random number) and the second ciphertext C_C. Note that as described above, the random number S (S_1, S_2, . . . ) is, among the encryption results output from the random function CC_K (encryption function) in the decryption of the first ciphertext C_O, a value other than the values (random number z; first random number) used for the decryption of the first ciphertext C_O.

More specifically, the second decryption unit 220 acquires a second plaintext M_C by using an exclusive OR of a value obtained by concatenating the random numbers S_1, S_2, . . . , and S_m (second random number) and the second ciphertext C_C. The second decryption unit 220 acquires msb{|C_C|} (S) obtained by truncating the random number S (=S_1∥S_2∥ . . . ∥S_m) so that it has a number of bits equal to the number of bits of the second ciphertext C_C. Then, the second decryption unit 220 acquires an exclusive OR of msb{|C_C|} (S) and the second ciphertext C_C as a second plaintext M_C corresponding to the second ciphertext C_C. The second decryption unit 220 outputs the second plaintext M_C to the output unit 280.

The second tag generation unit 250 of the verification tag generation unit 262 generates a second tag T*_C for generating a verification tag T* in substantially the same manner as the above-described second tag generation unit 150 does. The second tag generation unit 250 generates the second tag T*_C by the CP method by using the second ciphertext C_C. Specifically, as shown in FIG. 16, the second tag generation unit 250 generates the second tag T*_C by using bit strings L_3 and L_4 (second values) obtained by encrypting the nonce N using the random function CC_K and the second ciphertext C_C. More specifically, the second tag generation unit 250 generates the second tag T*_C by a function by a message authentication code (MAC function) by using the bit strings L_3 and L_4 (second values) and the second ciphertext C_C. In this process, as described above, the second tag generation unit 250 uses the bit strings L_3 and L_4 each consisting of 128 bits (=n1) as keys corresponding to the keys R and S.

The second tag generation unit 250 inputs the second ciphertext C_C, the associated data A, and the keys L_3 and L_4 to the MAC function according to Poly1305 used in the CP method. In this way, the second tag generation unit 250 acquires a bit string consisting of 128 bits output from the MAC function as the second tag T*_C. Note that when there is no associated data A, no associated data A is input to the MAC function. The second tag generation unit 250 outputs the second tag T*_C to the tag integration unit 260.

The verification tag generation unit 262 generates a verification tag T*. The tag integration unit 260 integrates (i.e., combines) the first and second tags T* O and T*_C and thereby generates one verification tag T*. Specifically, as shown in FIG. 15, the tag integration unit 260 acquires an exclusive OR of the first and second tags T*_O and T*_C as the verification tag T*. That is, the verification tag generation unit 262 generates a first tag T*_O, generates the second tag T*_C, and generates the verification tag T*. The verification tag generation unit 262 (tag integration unit 260) outputs the verification tag T* to the verification unit 270.

The verification unit 270 compares the verification tag T* generated by the tag integration unit 260 with the authentication tag T generated by the authenticated encryption apparatus 10, and thereby verifies whether or not tampering has occurred. Then, the verification unit 270 performs control for outputting information based on the result of the verification. That is, the verification unit 270 compares the verification tag T* with the input authentication tag T, and thereby verifies whether or not tampering has occurred. Then, the verification unit 270 performs control for outputting the result of the verification.

Specifically, the verification unit 270 compares the authentication tag T with the verification tag T*. Then, the verification unit 270 determines that the authentication has succeeded when the verification tag T* matches the authentication tag T. Then, when the authentication has succeeded, the verification unit 270 performs control for outputting a plaintext M obtained from the first plaintext M_O generated by the first decryption unit 210 and the second plaintext M_C generated by the first decryption unit 210. On the other hand, when the verification tag T* does not match the authentication tag T, the verification unit 270 determines that the authentication has failed. When the authentication has failed, the verification unit 270 performs control for outputting an error message 1 indicating that the authentication has failed.

When the authentication has succeeded, the output unit 280 outputs the plaintext M. Note that the output unit 280 may generate a plaintext M corresponding to the ciphertext C by using the first and second plaintexts M_O and M_C as follows. That is, the output unit 280 divides the second plaintext M_C into plaintext blocks M_C[1], . . . , and M_C[m] each consisting of 384 bits (=n3). Note that the number of bits of the plaintext block M_C[m] is equal to the number of bits of the ciphertext block C_C[m]. Further, the output unit 280 concatenates, for each of the indexes i=1, . . . , and m, the plaintext block M_O[i] consisting of 128 bits (=n1) and the plaintext block M_C[i] consisting of 384 bits (=n3), and thereby acquires a plaintext part M[i] consisting of 512 bits (=n2). That is, M[i] is equal to M_O[i]∥M_C[i] (M[i]=M_O[i]∥M_C[i]). Note that the number of bits of M[m] is equal to the number of bits of C[m]. Then, the output unit 280 acquires a plaintext M by concatenating the plaintext parts M[1], . . . , and M[m]. That is, C is equal to M[1]∥ . . . ∥M[m] (M=M[1]∥ . . . ∥M[m]).

On the other hand, when the authentication has failed, the output unit 280 outputs an error message ⊥. Note that the output unit 280 may, for example, perform control so as to make an output device such as a display device display information. Further, the output unit 280 may, for example, perform control so as to make an external apparatus connected thereto through a network output information.

### <Authenticated Encryption Method And Authenticated Decryption Method>

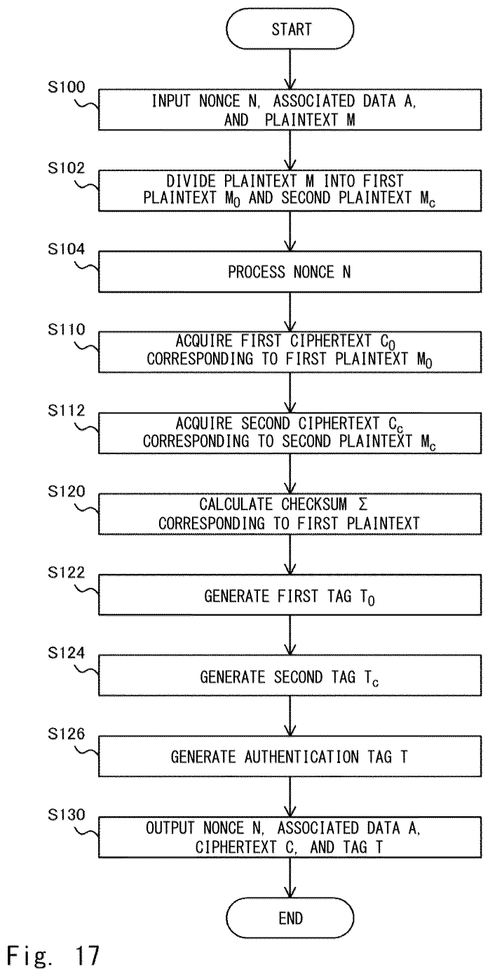

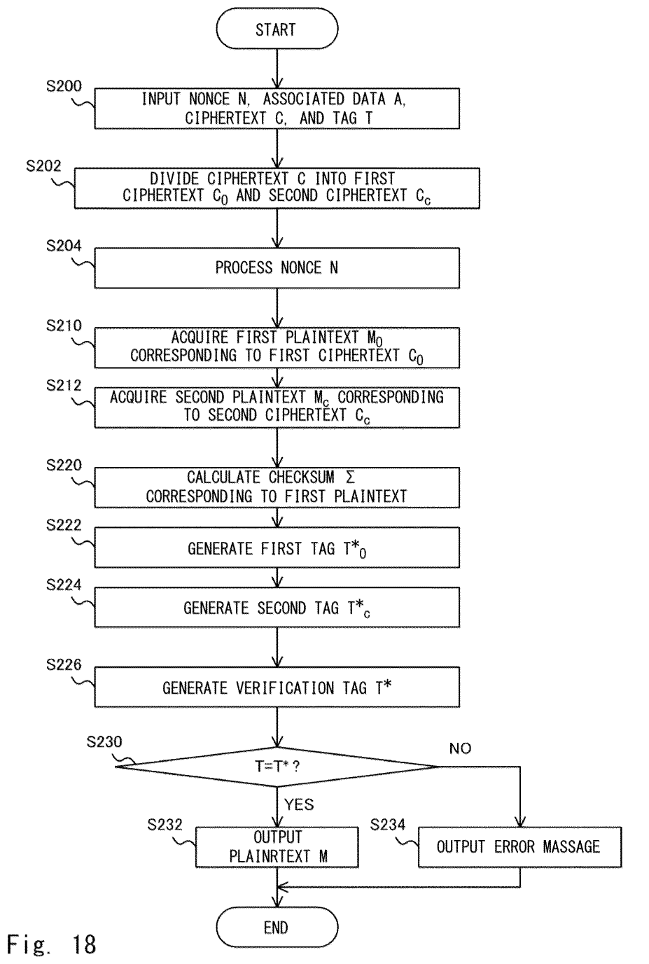

Next, operations performed by the authenticated encryption system 1 according to the present disclosure will be described with reference to FIGS. 17 and 18. FIG. 17 is a flowchart showing an authenticated encryption method performed by the authenticated encryption apparatus 10 according to the present disclosure.

As described above, the input unit 100 receives a nonce N, a plaintext M, and associated data A (Step S100). As described above, the plaintext division unit 102 divides the plaintext M into a first plaintext M_O and a second plaintext M_C at a predetermined ratio (Step S102). As described above, the nonce processing unit 104 processes the nonce N by using the random function CC_K, and thereby acquire bit strings L_1, L_2, L_3 and L_4 (Step S104).

As described above, the first encryption unit 110 acquires a first ciphertext C_O corresponding to the first plaintext M_O by the OTR method by using the random function CC_K (Step S110). Further, as described above, the second encryption unit 120 acquires a second ciphertext C_C corresponding to the second plaintext M_C by the CP method (Step S112).

As described above, the checksum calculation unit 130 calculates a checksum Σ corresponding to the first plaintext M_O (Step S120). As described above, the first tag generation unit 140 of the authentication tag generation unit 162 generates a first tag T_O by the OTR method by using the checksum Σ (Step S122). Further, as described above, the second tag generation unit 150 of the authentication tag generation unit 162 generates a second tag T_C by the CP method by using the second ciphertext C_C (Step S124). The authentication tag generation unit 162 generates an authentication tag T (Step S126). Specifically, as described above, the tag integration unit 160 integrates (i.e., combines) the first and second tags T_O and T_C, and thereby generates the authentication tag T. The output unit 170 performs control for outputting the nonce N, the associated data A, the ciphertext C, and the authentication tag T (Step S130).

FIG. 18 is a flowchart showing an authenticated decryption method performed by the authenticated decryption apparatus 20 according to the present disclosure. As described above, the input unit 200 receives a nonce N, associated data A, a ciphertext C, and an authentication tag T (Step S200). As described above, the ciphertext division unit 202 divides the ciphertext C into a first ciphertext C_O and a second ciphertext C_C at a predetermined ratio (Step S202). As described above, the nonce processing unit 204 processes the nonce N by using the random function CC_K, and thereby acquires bit strings L_1, L_2, L_3 and L_4 (Step S204).

As described above, the first decryption unit 210 acquires a first plaintext M_O corresponding to the first ciphertext C_O by the OTR method by using the random function CC_K (Step S210). Further, as described above, the second decryption unit 220 acquires a second plaintext M_C corresponding to the second ciphertext C_C by the CP method (Step S212).

As described above, the checksum calculation unit 230 calculates a checksum Σ corresponding to the first plaintext M_O (Step S220). As described above, the first tag generation unit 240 of the verification tag generation unit 262 generates a first tag T*_O by the OTR method by using the checksum Σ (Step S222). Further, as described above, the second tag generation unit 250 of the verification tag generation unit 262 generates a second tag T*_C by the CP method by using the second ciphertext C_C (Step S224). The verification tag generation unit 262 generates a verification tag T* (Step S226). Specifically, as described above, the tag integration unit 260 integrates (i.e., combines) the first and second tags T*_O and T*_C, and thereby generates the verification tag T*.

The verification unit 270 determines whether or not the verification tag T* matches the authentication tag T (Step S230). When the verification tag T* matches the authentication tag T (Yes in Step S230), it is considered that the authentication has succeeded, so that the output unit 280 outputs the plaintext M (Step S232). When the verification tag T* does not match the authentication tag T (No in Step S230), it is considered that the authentication has failed, so that the output unit 280 outputs an error message ⊥ (Step S234).

### <Effects>

Effects of the authenticated encryption apparatus 1 according to the first example embodiment will be described. Although effects of the authenticated encryption apparatus 10 will be described hereinafter, similar effects can also be achieved by the authenticated decryption apparatus 20. This fact also applies to other example embodiments.

As described above, the authenticated encryption apparatus 10 according to the first example embodiment divides a plaintext M into a first plaintext M_O and a second plaintext M_C. Then, the authenticated encryption apparatus 10 acquires, for the first plaintext M_O, a first ciphertext C_O through a process corresponding to the OTR method by using the random function CC_K, which is a cryptographic primitive of which the output length is longer than the input length. Further, the authenticated encryption apparatus 10 acquires a second ciphertext C_C corresponding to the second plaintext M_C by an exclusive OR of the second plaintext M_C and a key stream as being performed in the process corresponding to the CP method according to the first comparative example. As a result, the authenticated encryption apparatus 10 according to the first example embodiment can reduce the computational cost compared with the CP method according to the first comparative example by using the random function CC_K used in the first comparative example. That is, the authenticated encryption apparatus 10 according to the first example embodiment can efficiently perform an authenticated encryption process by using the cryptographic primitive of which the output length is longer than the input length.

Further, the authenticated encryption apparatus 10 according to the first example embodiment uses a random number S as a key stream that is used when the second plaintext M_C is processed. Note that as described above, the random number S corresponds to an excess bit string. By encrypting the second plaintext M_C through the process corresponding to the CP method by using the random number S, which is an excess bit string, as a key stream as described above, the authenticated encryption apparatus 10 can reduce the number of calls to the random function CC_K. That is, in the first comparative example, it is necessary to perform a counter mode using the random function CC_K in order to generate a key stream. That is, in the first comparative example, it is necessary to call the random function CC_K a number of times corresponding to the number m of blocks of the plaintext M (=|M|/512) in order to generate a key stream. In contrast, since the authenticated encryption apparatus 10 according to the first example embodiment uses an excess bit string as a key stream, there is no need to call the random function CC_K just to generate a key stream.

Further, in the authenticated encryption apparatus 10 according to the first example embodiment, the number of calls to the random function CC_K in the encryption process of a plaintext is m. For this matter, a third comparative example in which the cryptographic primitive used in the OTR method according to the second comparative example is simply changed from the block encryption function E_K to the random function CC_K will be examined. That is, assume that the plaintext M is entirely encrypted by the OTR method in the third comparative example. Further, assume that the above-described excess bit string (random number S) is not used in the third comparative example. Note that the number of bits of a plaintext block processed by one two-stage Feistel structure is 128×2 bits, and the number of calls to the random function CC_K in one two-stage Feistel structure is two. Therefore, in the third comparative example, the number of calls to the random function CC_K in the encryption of a plaintext M is 4 m. Note that m is expressed as m=|M|/512. Therefore, the number of calls to the random function CC_K in the encryption process of a plaintext in the authenticated encryption apparatus 10 according to the first example embodiment is much smaller than the number of calls to the random function CC_K in the encryption process of a plaintext in the third comparative example. As described above, the authenticated encryption apparatus 10 according to the first example embodiment can reduce the computational cost compared with the third comparative example.

Further, the authenticated encryption apparatus 10 according to the first example embodiment can reduce the computational cost in the processing of the MAC function. That is, in the CP method according to the first comparative example, the amount of data processed by the MAC function according to Poly1305 is |AD|+|M| bits. In contrast, in the authenticated encryption apparatus 10 according to the first example embodiment, the amount of data processed by the MAC function is |AD|+(n3/n2)|M| bits=|AD|+(¾)|M| bits. As described above, the authenticated encryption apparatus 10 according to the first example embodiment can reduce the amount of data processed by the MAC function compared with the CP method according to the first comparative example. Therefore, the authenticated encryption apparatus 10 according to the first example embodiment can reduce the computational cost compared with the CP method according to the first comparative example.

Note that in the authenticated encryption apparatus 10 according to the first example embodiment, the random function CC_K is called once in the process of the nonce; the random function CC_K is called m times in the encryption process of a plaintext; and the random function CC_K is called once in the tag generation process. Therefore, in the authenticated encryption apparatus 10 according to the first example embodiment, the number of calls to the random function CC_K is m+2. In contrast, in the CP method according to the first comparative example, the random function CC_K is called once in the process for generating keys R and S which are input to the MAC function, and the random function CC_K is called m times in the process for generating a key stream Z. Therefore, in the CP method according to the first comparative example, the number of calls to the random function CC_K is m+1. As described above, in the authenticated encryption apparatus 10 according to the first example embodiment, the number of calls to the random function CC_K is increased only once compared with the CP method according to the first comparative example. Meanwhile, the amount of data processed by the MAC function is reduced as described above, and therefore it is considered that the overall computational cost is reduced in the authenticated encryption apparatus 10 according to the first example embodiment compared with the first comparative example.

Further, the authenticated encryption apparatus 10 according to the first example embodiment is configured so as to divide a plaintext M into a first plaintext M_O and a second plaintext M_C based on the ratio between the input length n1 of the random function CC_K and the length n3 obtained by subtracting the input length n1 from the output length n2 thereof. That is, the authenticated encryption apparatus 10 according to the first example embodiment divides a plaintext M into a first plaintext M_O and a second plaintext M_C so that their lengths are expressed as |M_O|:|M_C|=128:384. By the above-described configuration, it is possible to perform an authenticated encryption process more efficiently. That is, it is possible to reduce the computational cost compared with the first comparative example more reliably. For example, when the ratio of the number of bits of the second plaintext M_C is increased from the above-described ratio, although the amount of data processed by the MAC function increases compared with the case of the first example embodiment, the number of calls to the random function CC_K may not be reduced so much. Further, when the ratio of the number of bits of the second plaintext M_C is reduced from the above-described ratio, although the amount of data processed by the MAC function decreases compared with the case of the first example embodiment, the number of calls to the random function CC_K may considerably increase. Therefore, considering the balance between the number of calls to the random function CC_K and the amount of data processed by the MAC function, it is possible to perform an authenticated encryption process more efficiently by dividing the plaintext M so that the lengths of divided plaintexts are expressed as M_O|:|M_C|=128:384.

Further, as described above, the nonce processing unit 104 is configured to encrypt the nonce N by using the random function CC_K and thereby acquire bit strings L_1, L_2, L_3 and L_4. In this way, it is possible to acquire values that are necessary in view of the security, such as mask values and keys, without increasing the number of calls to the cryptographic primitive. That is, in the case where the bit strings L_1, L_2, L_3 and L_4 are separately acquired, the cryptographic primitive needs to be called four times. Further, in the case where the value that is used when a mask value used in the encryption process of the first plaintext M_O is acquired and the key that is used when the second tag T_C corresponding to the second plaintext M_C is generated are acquired separately from each other, the cryptographic primitive needs to be called twice. In contrast, the nonce processing unit 104 acquires bit strings L_1, L_2, L_3 and L_4 by calling the random function CC_K only once. Therefore, by the above-described configuration, it is possible to prevent or minimize the increase in the number of calls to the cryptographic primitive which would otherwise need to be increased in order to acquire values that are necessary in view of the security.

### <Modified Example of First Example Embodiment>

A modified example of the first example embodiment will be described hereinafter. In the authenticated encryption apparatus 10 according to the above-described first example embodiment, the random function CC_K used in the first comparative example (NPL 1) is used as the cryptographic primitive. However, the used cryptographic primitive is not limited to the random function CC_K. That is, any cryptographic primitive of which the output length is longer than the input length may be used. This fact also applies to the authenticated decryption apparatus 20 according to the first example embodiment. Further, this modified example can also be applied to other example embodiments described later.

For example, the authenticated encryption apparatus 10 according to the first example embodiment may perform an authenticated encryption process by using a cryptographic primitive used in an encryption method “SalSa20” disclosed in NPL 4. Further, the authenticated encryption apparatus 10 according to the first example embodiment may perform an authenticated encryption process by using a cryptographic primitive such as one used in an encryption method “XSalSa20” disclosed in NPL 5 or an encryption method “XChaCha20” disclosed in NPL 6. Note that the cryptographic primitive used in “XSalSa20” disclosed in NPL 5 and “XChaCha20” disclosed in NPL 6 are referred to as “xCC”. The cryptographic primitive “xCC” is a cryptographic primitive having an input length of 256 bits and an output length of 512 bits.

When xCC is used, a first modified example and a second modified example described hereinafter are conceivable. The first modified example corresponds to a configuration that is obtained by simply replacing the random function CC_K shown in FIGS. 5 to 9 by xCC. Therefore, a relation |M_O|:|M_C|=256:256=1:1 holds. Therefore, the number of bits of the plaintext block M_[i] is 256 bits. Further, the number of bits of the second plaintext M_C is 256×m bits. In this case, the computational cost is as follows. That is, since xCC consists of two functions CC_K, when xCC is called once, the random function CC_K is called twice. Therefore, the number of calls to the random function CC_K is (m+2)×2=2m+4 times. Meanwhile, the amount of data processed by the MAC function is |AD|+(256/512)|M| bits=|AD|+(½)|M| bits.

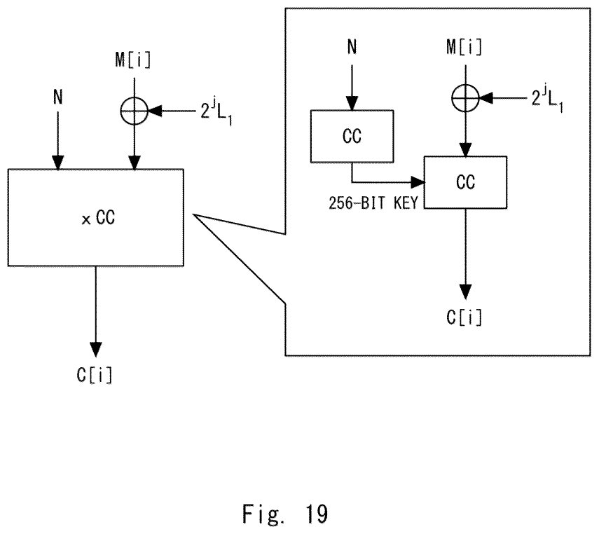

FIG. 19 is a diagram for explaining the second modified example. In the second modified example, a nonce N, which is unchanged for the processing of one plaintext M, is input in the upper 128 bits of xCC, and a 256-bit key is generated. Further, similarly to the first example embodiment, an exclusive OR of a 128-bit plaintext block M[i] and a mask value 2j. L_1 is input in the lower 128 bits. As a result, a ciphertext block C[i] corresponding to the plaintext block M[i] is obtained. Therefore, there is no need to call the random function CC_K, in which the nonce Nis input, every time xCC is called. Therefore, in the second modified example, it is sufficient if the random function CC_K is called only once when xCC is called once. In such a configuration, since the relation |M_O|:|M_C|=128:384 holds, the computational cost is equal to that in the above-described first example embodiment.

### Second Example Embodiment

Next, a second example embodiment will be described. For the sake of clarifying the explanation, the following descriptions and drawings are omitted and simplified as appropriate. Further, the same elements are assigned the same reference numerals (or symbols) throughout the drawings, and redundant descriptions are omitted as appropriate. Note that since a configuration of a system according to the second example embodiment is substantially the same as that according to the first example embodiment, the description thereof will be omitted. That is, the authenticated encryption system 1 according to the second example embodiment includes the authenticated encryption apparatus 10A corresponding to the authenticated encryption apparatus 10 and the authenticated decryption apparatus 20A corresponding to the authenticated decryption apparatus 20.

### <Authenticated Encryption Apparatus>

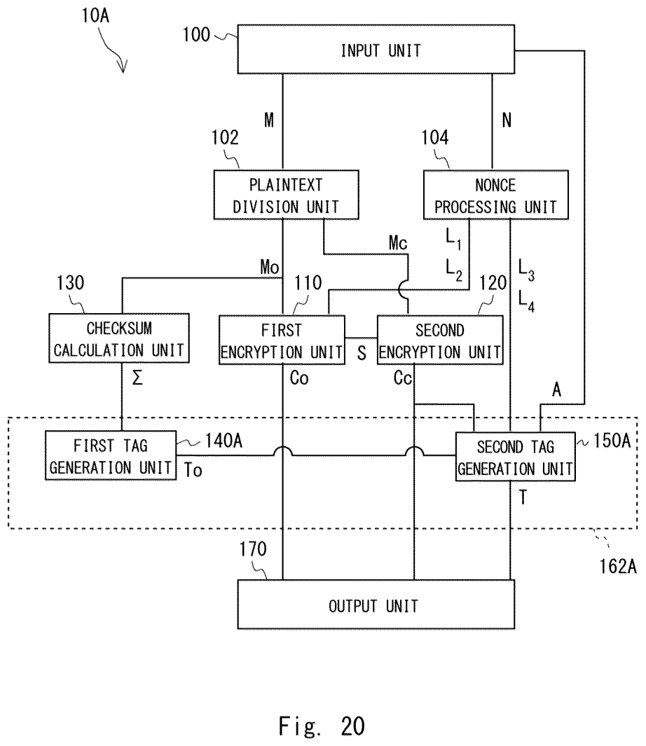

FIG. 20 shows a configuration of the authenticated encryption apparatus 10A according to the present disclosure. The authenticated encryption apparatus 10A according to the second example embodiment includes an input unit 100, a plaintext division unit 102, and a nonce processing unit 104. Further, the authenticated encryption apparatus 10A according to the second example embodiment includes a first encryption unit 110, a second encryption unit 120, a checksum calculation unit 130, a first tag generation unit 140A, a second tag generation unit 150A, and an output unit 170. Further, the first and second tag generation units 140A and 150A constitute an authentication tag generation unit 162A. That is, the authenticated encryption apparatus 10A includes the authentication tag generation unit 162A. The components other than the first tag generation unit 140A, the second tag generation unit 150A, and the authentication tag generation unit 162A are substantially the same as those in the first example embodiment, and therefore descriptions thereof will be omitted.

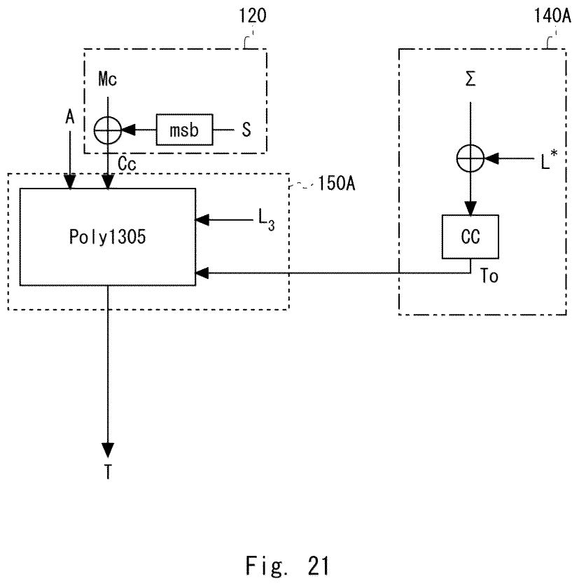

FIG. 21 shows an outline of operations in an authenticated encryption process performed by the authenticated encryption apparatus 10A according to the present disclosure. The first tag generation unit 140A of the authentication tag generation unit 162A generates a first tag T_O in substantially the same manner as the above-described first tag generation unit 140 does. Then, the first tag generation unit 140A outputs the first tag T_O to the second tag generation unit 150A.

The second tag generation unit 150A of the authentication tag generation unit 162A generates a tag by using the MAC function according to Poly1305 used in the CP method in substantially the same manner as the second tag generation unit 150 does. Specifically, as shown in FIG. 21, the second tag generation unit 150A generates an authentication tag T by using a bit string L_3 obtained by encrypting the nonce N using the random function CC_K, the first tag T_O, and the second ciphertext C_C. More specifically, the second tag generation unit 150A generates an authentication tag T by a function by a message authentication code (MAC function) by using the bit string L_3 (second value), the first tag T_O, and the second ciphertext C_C. In this process, the second tag generation unit 150A uses the bit string L_3 as a key corresponding to the key R and uses the first tag T_O as a key corresponding to the key S.

The second tag generation unit 150A inputs the second ciphertext C_C, associated data A, the key L_3, and the first tag T_O to the MAC function according to Poly1305 used in the CP method. In this way, the second tag generation unit 150A acquires a bit string consisting of 128 bits output from the MAC function as an authentication tag T. That is, the authentication tag generation unit 162A generates a second tag T_C output from the MAC function as an authentication tag T. Note that when there is no associated data A, no associated data A is input to the MAC function. The authentication tag generation unit 162A (second tag generation unit 150A) outputs the authentication tag T to the output unit 170.

### <Authenticated Decryption Apparatus>

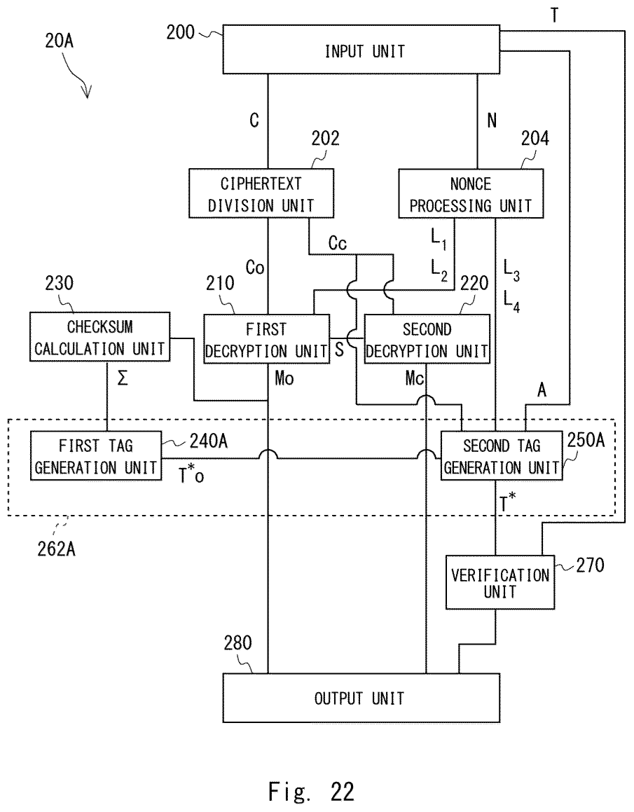

FIG. 22 shows a configuration of an authenticated decryption apparatus 20A according to the present disclosure. The authenticated decryption apparatus 20A according to the second example embodiment includes an input unit 200, a ciphertext division unit 202, and a nonce processing unit 204. Further, the authenticated decryption apparatus 20A according to the second example embodiment includes a first decryption unit 210, a second decryption unit 220, a checksum calculation unit 230, a first tag generation unit 240A, a second tag generation unit 250A, a verification unit 270, and an output unit 280. Further, the first tag generation unit 240A and the second tag generation unit 250A constitute a verification tag generation unit 262A. That is, the authenticated decryption apparatus 20A includes the verification tag generation unit 262A. The components other than the first and second tag generation units 240A and 250A, and the verification tag generation unit 262A are substantially the same as those in the first example embodiment, and therefore descriptions thereof will be omitted.

The first tag generation unit 240A of the verification tag generation unit 262A generates a first tag T*_O substantially in the same manner as the above-described first tag generation unit 240 does. Then, the first tag generation unit 240A outputs the first tag T*_O to the second tag generation unit 250A.

Similarly to the second tag generation unit 250, the second tag generation unit 250A of the verification tag generation unit 262A generates a tag using the MAC function according to Poly1305 used in the CP method. Specifically, the second tag generation unit 250A generates a verification tag T* substantially in the same manner as the process performed by the second tag generation unit 150A. That is, the second tag generation unit 250A generates a verification tag T* by using a bit string L_3 obtained by encrypting the nonce N using the random function CC_K, the first tag T*_O, and the second ciphertext C_C. More specifically, the second tag generation unit 250A generates an authentication tag T by a function by a message authentication code (MAC function) by using the bit string L_3 (second value), the first tag T*_O, and the second ciphertext C_C. In this process, the second tag generation unit 250A uses the bit string L_3 as a key corresponding to the key R and uses the first tag T*_O as a key corresponding to the key S.

The second tag generation unit 250A inputs the second ciphertext C_C, associated data A, the key L_3, and the first tag T*_O to the MAC function according to Polyl305 used in the CP method. In this way, the second tag generation unit 250A acquires a bit string consisting of 128 bits output from the MAC function as a verification tag T*. That is, the verification tag generation unit 262A generates a second tag T*_C output from the MAC function as a verification tag T*. Note that when there is no associated data A, no associated data A is input to the MAC function. The verification tag generation unit 262A (second tag generation unit 250A) outputs the verification tag T* to the verification unit 270.

### <Effects>

The authenticated encryption apparatus 10A according to the second example embodiment provides substantially the same effects as those provided by the authenticated encryption apparatus 10 according to the first example embodiment as described above. Further, the authenticated encryption apparatus 10A according to the second example embodiment is configured so as to generate an authentication tag T by inputting the first tag T_O, instead of the bit string L_4, to the MAC function according to Poly1305. Therefore, in the authenticated encryption apparatus 10A according to the second example embodiment, the processing performed by the tag integration unit 160 is unnecessary. That is, in the authenticated encryption apparatus 10A according to the second example embodiment, the process for calculating an exclusive OR in the tag integration unit 160 is unnecessary.

Further, even when the bit string L_4 cannot be obtained for some reason, the authentication tag T can be generated by using the first tag T_O. For example, in the case where the nonce N is processed by using the above-described xCC as the cryptographic primitive, the value L_4 may not be derived when xCC is called only once. Even in such a case, the authenticated encryption apparatus 10A according to the second example embodiment can generate an authentication tag T without increasing the number of calls to the encryption function.

### Third Example Embodiment

Next, a third example embodiment will be described. As the third example embodiment, an outline of the configuration according to the above-described example embodiment will be shown.

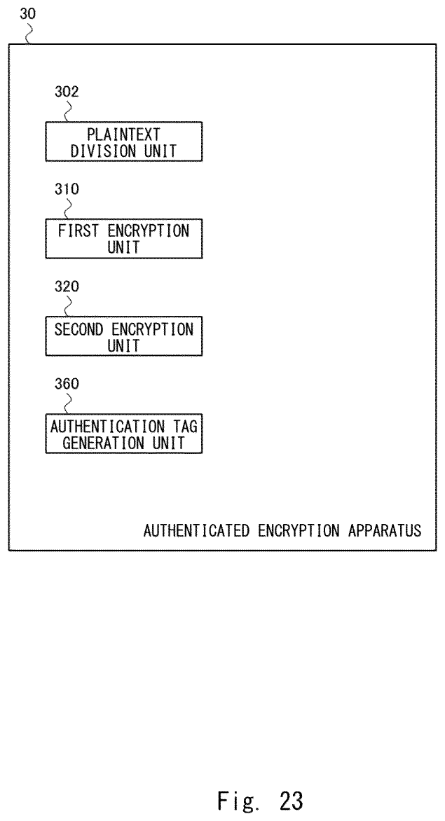

FIG. 23 shows a configuration of an authenticated encryption apparatus 30 according to the present disclosure. The authenticated encryption apparatus 30 according to the third example embodiment corresponds to the authenticated encryption apparatus according to the above-described other example embodiments. The authenticated encryption apparatus 30 according to the third example embodiment includes a plaintext division unit 302, a first encryption unit 310, a second encryption unit 320, and an authentication tag generation unit 360.

The plaintext division unit 302 functions as plaintext division meas. The first encryption unit 310 functions as first encryption means. The second encryption unit 320 functions as second encryption means. The authentication tag generation unit 360 functions as authentication tag generation means. Note that the authenticated encryption apparatus 30 according to the third example embodiment uses an encryption function corresponding to a cryptographic primitive of which the output length n2 is longer than the input length n1. The encryption function is, for example, but not limited to, the random function CC_K used in the first comparative example. This feature also applies to an authenticated decryption apparatus 40 according to the third example embodiment.

The plaintext division unit 302 can be implemented by substantially the same function as that of the above-described plaintext division unit 102. The plaintext division unit 302 divides a plaintext M into a first plaintext M_O and a second plaintext M_C at a predetermined ratio. The plaintext division unit 302 may divide a plaintext M so that, for example, a relation |M_O|:|M_C|=(Input length n1):(Output length n2−Input length n1) holds.

The first encryption unit 310 may be implemented by substantially the same function as that of the above-described first encryption unit 110. The first encryption unit 310 acquires a plurality of ciphertext blocks by the encryption function by using a mask value obtained based on first values (L_1 and L_2) and a plurality of plaintext blocks M_O[i], respectively, and thereby acquires a first ciphertext C_O. Note that the first values (L_1 and L_2) are obtained by encrypting the nonce N using the encryption function. Further, the plurality of plaintext blocks M_O[i] are obtained by dividing the first plaintext M_O into parts each having a length corresponding to the input length of the encryption function. Further, the plurality of ciphertext blocks correspond to the plurality of plaintext blocks. Further, the first ciphertext C_O corresponds to a value in which the first plaintext M_O is encrypted.

The second encryption unit 320 can be implemented by substantially the same function as that of the above-described second encryption unit 120. The second encryption unit 320 acquires a second ciphertext C_C, in which the second plaintext M_C is encrypted, by using a value S and the second plaintext M_C. The value S is, among the encryption results output from the encryption function in the encryption of the first plaintext M_O, a value other than the values used for the encryption of the first plaintext. Note that as described above, the value S (random number S) is, among the encryption results output from the encryption function in the encryption of the first plaintext M_O, a value other than the values (random numbers z) used for the encryption of the first plaintext M_O.

The authentication tag generation unit 360 can be implemented by substantially the same function as that of the above-described authentication tag generation unit 162 or the authentication tag generation unit 162A. The authentication tag generation unit 360 generates a first tag T_O by the encryption function by using a value (checksum Σ) obtained based on an exclusive OR of some of a plurality of plaintext blocks and a mask value obtained based on the first value. Further, the authentication tag generation unit 360 generates a second tag T_C by using a second value (L_3) obtained by encrypting the nonce using the encryption function and the second ciphertext C_C.

Further, the authentication tag generation unit 360 generates an authentication tag T. Note that similarly to the authentication tag generation unit 162 according to the first example embodiment, the authentication tag generation unit 360 may generate an authentication tag T by integrating (i.e., combining) the first and second tags T_O and T_C. Alternatively, similarly to the authentication tag generation unit 162A according to the second example embodiment, the authentication tag generation unit 360 may generate a second tag T_C, which is generated by using the second ciphertext C_C and the first tag T_O, as an authentication tag T.

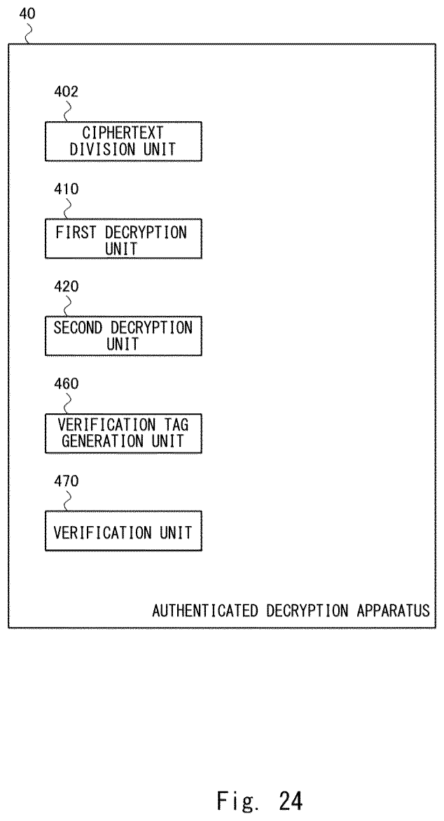

FIG. 24 shows a configuration of an authenticated decryption apparatus 40 according to the present disclosure. The authenticated decryption apparatus 40 according to the third example embodiment corresponds to the authenticated encryption apparatus according to other example embodiments. The authenticated decryption apparatus 40 according to the third example embodiment includes a ciphertext division unit 402, a first decryption unit 410, a second decryption unit 420, a verification tag generation unit 460, and a verification unit 470.

The ciphertext division unit 402 functions as ciphertext division means. The first decryption unit 410 functions as first decryption means. The second decryption unit 420 functions as second decryption means. The verification tag generation unit 460 functions as verification tag generation means. The verification unit 470 functions as verification means.

The ciphertext division unit 402 can be implemented by substantially the same function as that of the ciphertext division unit 202. The ciphertext division unit 402 divides a ciphertext C into a first ciphertext C_O and a second ciphertext C_C at a predetermined ratio. The ciphertext division unit 402 may divide a ciphertext C so that, for example, a relation |C_O|:|C_C|=(Input length n1):(Output length n2−Input length n1) holds.

The first decryption unit 410 may be implemented by substantially the same function as that of the first decryption unit 210. The first decryption unit 410 acquires a plurality of plaintext blocks by the encryption function by using a mask value obtained based on first values (L_1 and L_2) and a plurality of ciphertext blocks C_O[i], respectively, and thereby acquires a first plaintext M_O. Note that the first values (L_1 and L_2) are obtained by encrypting the nonce N using the encryption function. Further, the plurality of ciphertext blocks C_O[i] are obtained by dividing the first ciphertext C_O into parts each having a length corresponding to the input length of the encryption function. Further, the plurality of plaintext blocks correspond to the plurality of ciphertext blocks. Further, the first plaintext M_O corresponds to a value obtained by decrypting the first ciphertext C_O.

The second decryption unit 420 can be implemented by substantially the same function as that of the above-described second decryption unit 220. The second decryption unit 420 acquires a second plaintext M_C, which is obtained by decrypting second ciphertext C_C, by using a value S and the second ciphertext. The value S is, among the encryption results output from the encryption function in the decryption of the first ciphertext C_O, a value other than the values used for the decryption of the first ciphertext. Note that as described above, the value S (random number S) is, among the encryption results output from the encryption function in the decrypting the first ciphertext C_O, a value other than the values (random numbers z) used for the decrypting the first ciphertext C_O.

The verification tag generation unit 460 can be implemented by substantially the same function as that of the above-described verification tag generation unit 262 or the verification tag generation unit 262A. The verification tag generation unit 460 generates a first tag T*_O by the encryption function by using a value (checksum Σ) obtained based on an exclusive OR of some of a plurality of plaintext blocks and a mask value obtained based on the first value. Further, the verification tag generation unit 460 generates a second tag T*_C by using a second value (L_3) obtained by encrypting the nonce using the encryption function, and the second ciphertext C_C.

Further, the verification tag generation unit 460 generates a verification tag T*. Note that similarly to the verification tag generation unit 262 according to the first example embodiment, the verification tag generation unit 460 may generate a verification tag T* by integrating (i.e., combining) a first tag T*_O and a second tag T*_C. Alternatively, similarly to the verification tag generation unit 262A according to the second example embodiment, the verification tag generation unit 460 may generate a second tag T*_C, which is generated by using the second ciphertext C_C and the first tag T*_O, as a verification tag T*.

The verification unit 470 may be implemented by substantially the same function as that of the above-described verification unit 270. The verification unit 470 verifies, by comparing the verification tag T* with the input authentication tag T, whether or not tampering has occurred, and performs control for outputting the result of the verification.

By the above-described the configuration, each of the authenticated encryption apparatus 30 and the authenticated decryption apparatus 40 according to the third example embodiment can efficiently perform an authenticated encryption process by using a cryptographic primitive of which the output length is longer than the input length. Further, it is also possible to efficiently perform an authenticated encryption process by using a cryptographic primitive of which the output length is longer than the input length by an authenticated encryption method performed by the authenticated encryption apparatus 30 or a program for performing such an authenticated encryption method. Further, it is also possible to efficiently perform an authenticated encryption process by using a cryptographic primitive of which the output length is longer than the input length by an authenticated decryption method performed by the authenticated decryption apparatus 40 or a program for performing such an authenticated decryption method.

### (Example of Hardware Configuration)

An example of a configuration of hardware resources for implementing an apparatus and a system according to the above-described example embodiment by using one calculation processing apparatus (an information processing apparatus or a computer) will be described. However, the apparatus according to any of the example embodiments (authenticated encryption apparatus and authenticated decryption apparatus) may be physically or functionally implemented by using at least two calculation processing apparatus. Further, the apparatus according to any of the example embodiments may be implemented as a dedicated apparatus or as a general-purpose information processing apparatus.

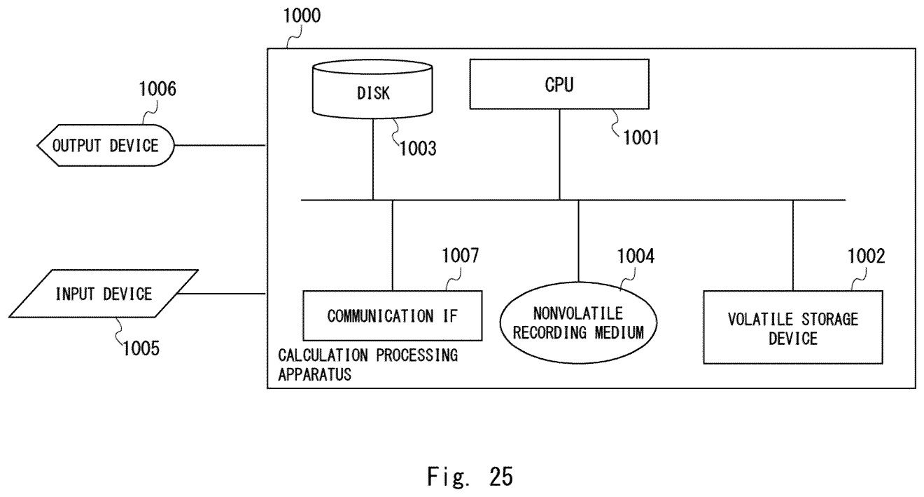

FIG. 25 is a block diagram schematically showing an example of a hardware configuration of a calculation processing apparatus capable of implementing an apparatus and a system according to the present disclosure. A calculation processing apparatus 1000 includes a CPU 1001, a volatile storage device 1002, a disk 1003, a nonvolatile recording medium 1004, and a communication IF (IF: Interface) 1007. Therefore, it can be said that the apparatus according to any of the example embodiments includes the CPU 1001, the volatile storage device 1002, the disk 1003, the nonvolatile recording medium 1004, and the communication IF 1007. The calculation processing apparatus 1000 may be configured so that it can be connected to an input device 1005 and an output device 1006. The calculation processing apparatus 1000 may include the input device 1005 and the output device 1006. Further, the calculation processing apparatus 1000 may transmit/receive information to/from other calculation processing apparatuses and communication apparatuses through the communication IF 1007.

The nonvolatile recording medium 1004 is, for example, a computer readable CD (Compact Disc) or a computer readable DVD (Digital Versatile Disc). Further, the nonvolatile recording medium 1004 may be a USB (Universal Serial Bus) memory, an SSD (Solid State Drive), or the like. The nonvolatile recording medium 1004 holds (i.e., retains) a relevant program(s) even when no electric power is supplied, thus enabling the program(s) to be carried and transported. Note that the nonvolatile recording medium 1004 is not limited to the above-described media. Alternatively, instead of using the nonvolatile recording medium 1004, the relevant program(s) may be supplied through the communication IF 1007 and a communication network(s).

The volatile storage device 1002 can be read by a computer, and can temporarily store data. The volatile storage device 1002 is a memory or the like such as a DRAM (dynamic random access memory) or an SRAM (static random access memory).

That is, the CPU 1001 copies (i.e., loads) a software program (a computer program: hereinafter also simply referred to as a “program”) stored in the disc 1003 into the volatile storage device 1002 when it executes the program, and thereby performs arithmetic processing. The CPU 1001 reads data necessary for executing the program from the volatile storage device 1002. When it is necessary to display an output result, the CPU 1001 displays the output result on the output device 1006. When a program is input from the outside, the CPU 1001 acquires the program through the input device 1005. The CPU 1001 interprets and executes programs corresponding to the above-described functions (the processes) of the respective components shown in FIGS. 4, 11, 20, 22, 23 and 24. The CPU 1001 performs the processes described in each of the above-described example embodiments. In other words, the above-described functions of the respective components shown in FIGS. 4, 11, 20, 22, 23 and 24 can be implemented by having the CPU 1001 execute a program(s) stored in the disc 1003 or the volatile storage device 1002.

That is, it can be considered that each example embodiment can be accomplished by the above-described program. Further, it can be considered that each of the above-described example embodiments can also be accomplished by a nonvolatile recording medium which can be read by a computer and in which the above-described program is recorded.

### (Modified Example)

Note that the present invention is not limited to the above-described example embodiments, and they may be modified as appropriate without departing from the scope and spirit of the invention. For example, in the above-described flowcharts, the order of processes (steps) can be changed as appropriate. Further, at least one of a plurality of processes (steps) may be omitted (or skipped). Further, the above-described plurality of example embodiments can be applied to each other. Further, although the plaintext M_O is defined as the “first plaintext” and the plaintext M_C is defined as the “second plaintext” in the above-described example embodiments, the present disclosure is not limited to such a configuration. The plaintext M_O may be defined as the “second plaintext” and the plaintext M_C may be defined as the “first plaintext”. This fact also applies to the first and second ciphertexts.

Further, the method for dividing a plaintext M into a first plaintext M_O and a second plaintext M_C is not limited to the above-described method performed by the plaintext division unit 102. For example, the plaintext division unit may first divide a plaintext M so that a relation |M_O|:|M_C|=(Input length n1):(Output length n2−Input length n1) holds. Then, the plaintext division unit may divide the first plaintext M_O into parts each having a number of bits corresponding to the length of the input length n1, and thereby acquire plaintext blocks M_O[1], . . . , and M_O[m]. Further, the plaintext division unit may divide the second plaintext M_C into parts each consisting of a number of bits corresponding to the length n3 (=Output length n2−Input length n1), and thereby acquire plaintext blocks M_C[1], . . . , and M_C[m]. In this case, the output unit may acquire a first ciphertext C_O by concatenating the ciphertext blocks C_O[1], . . . , and C_O[m] corresponding to the plaintext blocks M_O[1], . . . , and M_O[m], respectively. Further, the output unit may acquire a ciphertext C by concatenating the first and second ciphertexts C_O and C_C. These features also apply to the ciphertext division unit and the output unit in the authenticated decryption apparatus.

Further, in the above-described example embodiments, the plaintext division unit is configured so as to divide a plaintext M into a first plaintext M_O and a second plaintext M_C based on the ratio (128:384) between the input length n1 of the random function CC_K and the length n3 obtained by subtracting the input length n1 from the output length n2 thereof. However, the authenticated encryption apparatus according to this example embodiment is not limited to such a configuration. However, it is possible to perform an authenticated encryption process more efficiently by dividing a plaintext M into a first plaintext M_O and a second plaintext M_C based on the ratio of the input length n1 of the random function CC_K and the length n3 as described above. That is, it is possible reduce the computational cost by dividing a plaintext M into a first plaintext M_O and a second plaintext M_C based on the ratio of the input length n1 of the random function CC_K and the length n3. This feature also applies to the ciphertext division unit of the authenticated decryption apparatus according to this example embodiment.

Further, the method for acquiring a plurality of mask values used for the encryption of the first plaintext M_O is not limited to the above-described method. As the method for acquiring a plurality of mask values, any method in which any of a plurality of mask values is not identical to any of the other mask values may be adopted.

In the above-described examples, the program includes a set of instructions (or software codes) that, when being loaded into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disk (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Although the present invention is described above with reference to example embodiments, the present invention is not limited to the above-described example embodiments. Various modifications that can be understood by those skilled in the art can be made to the configuration and details of the present invention within the scope and spirit of the invention.

According to the present disclosure, it is possible to provide an authenticated encryption apparatus, an authenticated decryption apparatus, an authenticated encryption system, a method, and a program capable of efficiently performing an authenticated encryption process by using a cryptographic primitive of which the output length is longer than the input length.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The first, second and third example embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

The whole or part of the example embodiments disclosed above can be described as, but not limited to, the following supplementary notes.

### (Supplementary Note 1)

An authenticated encryption apparatus comprising:
plaintext division means for dividing a plaintext into a first plaintext and a second plaintext at a predetermined ratio;
first encryption means for acquiring, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquiring a first ciphertext in which the first plaintext is encrypted;
second encryption means for acquiring, by using, among encryption results output from the encryption function in the encryption of the first plaintext, a value other than a value used for the encryption of the first plaintext and the second plaintext, a second ciphertext in which the second plaintext is encrypted; and
authentication tag generation means for generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating an authentication tag.

### (Supplementary Note 2)

The authenticated encryption apparatus described in Supplementary note 1, wherein the plaintext division means divides the plaintext into the first plaintext and the second plaintext based on a ratio between the input length and a length obtained by subtracting the input length from the output length.

### (Supplementary Note 3)

The authenticated encryption apparatus described in Supplementary note 1, further comprising nonce processing means for encrypting the nonce using the encryption function, and thereby acquiring the first value and the second value.

### (Supplementary Note 4)

The authenticated encryption apparatus described in Supplementary note 1, wherein the first encryption means acquires the first ciphertext by using an exclusive OR of, among encryption results output from the encryption function, a first random number having a number of bits corresponding to the input length and the plaintext block.

### (Supplementary Note 5)

The authenticated encryption apparatus described in Supplementary note 4, wherein the second encryption means acquires the second ciphertext by using an exclusive OR of a value and the second plaintext, the value being obtained by concatenating second random numbers other than the first random number among the encryption results output from the encryption function in the encryption process of the first plaintext.

### (Supplementary Note 6)

The authenticated encryption apparatus described in Supplementary note 5, wherein the authentication tag generation means generates the second tag by a function of a message authentication code by using the second value and the second ciphertext.

### (Supplementary Note 7)

The authenticated encryption apparatus described in Supplementary note 1, further comprising checksum calculation means for calculating a checksum based on an exclusive OR of some of the plurality of plaintext blocks.

### (Supplementary Note 8)

The authenticated encryption apparatus described in Supplementary note 7, wherein the authentication tag generation means generates the first tag by the encryption function by using an exclusive OR of the checksum and a mask value obtained based on the first value.

### (Supplementary Note 9)

An authenticated decryption apparatus comprising:
ciphertext division means for dividing a ciphertext into a first ciphertext and a second ciphertext at a predetermined ratio;
first decryption means for acquiring, by an encryption function corresponding to a cryptographic primitive of which an output length is longer than an input length and by using a mask value obtained based on a first value obtained by encrypting a nonce using the encryption function and a plurality of ciphertext blocks, respectively, obtained by dividing the first ciphertext into blocks each having a length corresponding to the input length, a plurality of plaintext blocks corresponding to the plurality of ciphertext blocks, and thereby acquiring a first plaintext obtained by decrypting the first ciphertext;
second decryption means for acquiring, by using, among encryption results output from the encryption function in the decryption of the first ciphertext, a value other than a value used for the decryption of the first ciphertext and the second ciphertext, a second plaintext obtained by decrypting the second ciphertext;
verification tag generation means for generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating a verification tag; and
verification means for verifying whether tempering has occurred or not by comparing the verification tag with an input authentication tag, and performing control for outputting a verification result.

### (Supplementary Note 10)

The authenticated decryption apparatus described in Supplementary note 9, wherein the ciphertext division means divides the ciphertext into the first ciphertext and the second ciphertext based on a ratio between the input length and a length obtained by subtracting the input length from the output length.

### (Supplementary Note 11)

The authenticated decryption apparatus described in Supplementary note 9, further comprising nonce processing means for encrypting the nonce using the encryption function, and thereby acquiring the first value and the second value.

### (Supplementary Note 12)

The authenticated decryption apparatus described in Supplementary note 9, wherein the first decryption means acquires the first plaintext by using an exclusive OR of, among encryption results output from the encryption function, a first random number having a number of bits corresponding to the input length and the ciphertext block.

### (Supplementary Note 13)

The authenticated decryption apparatus described in Supplementary note 12, wherein the second decryption means acquires the second plaintext by using an exclusive OR of a value and the second ciphertext, the value being obtained by concatenating second random numbers other than the first random number among the encryption results output from the encryption function in the decryption process of the first ciphertext.

### (Supplementary Note 14)

The authenticated decryption apparatus described in Supplementary note 13, wherein the verification tag generation means generates the second tag by a function of a message authentication code by using the second value and the second ciphertext.

### (Supplementary Note 15)

The authenticated decryption apparatus described in Supplementary note 9, further comprising checksum calculation means for calculating a checksum based on an exclusive OR of some of the plurality of plaintext blocks.

### (Supplementary Note 16)

The authenticated decryption apparatus described in Supplementary note 15, wherein the verification tag generation means generates the first tag by the encryption function by using an exclusive OR of the checksum and a mask value obtained based on the first value.

### (Supplementary Note 17)

An authenticated encryption system comprising:
an authenticated encryption apparatus; and
an authenticated decryption apparatus configured to communicate with the authenticated encryption apparatus, wherein
the authenticated encryption apparatus comprises:
plaintext division means for dividing a plaintext into a first plaintext and a second plaintext at a predetermined ratio;
first encryption means for acquiring, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquiring a first ciphertext in which the first plaintext is encrypted;
second encryption means for acquiring, by using, among encryption results output from the encryption function in the encryption of the first plaintext, a value other than a value used for the encryption of the first plaintext and the second plaintext, a second ciphertext in which the second plaintext is encrypted; and
authentication tag generation means for generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating an authentication tag, and
the authenticated decryption apparatus comprises:
ciphertext division means for dividing a ciphertext into a first ciphertext and a second ciphertext at a predetermined ratio;
first decryption means for acquiring, by the encryption function and by using the mask value obtained based on the first value obtained by encrypting the nonce using the encryption function and a plurality of ciphertext blocks, respectively, obtained by dividing the first ciphertext into blocks each having a length corresponding to the input length, a plurality of plaintext blocks corresponding to the plurality of ciphertext blocks, and thereby acquiring a first plaintext obtained by decrypting the first ciphertext;
second decryption means for acquiring, by using, among encryption results output from the encryption function in the decryption of the first ciphertext, a value other than a value used for the decryption of the first ciphertext and the second ciphertext, a second plaintext obtained by decrypting the second ciphertext;
verification tag generation means for generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating a verification tag; and
verification means for verifying whether tempering has occurred or not by comparing the verification tag with an input authentication tag, and performing control for outputting a verification result.

### (Supplementary Note 18)

An authenticated encryption method comprising:
dividing a plaintext into a first plaintext and a second plaintext at a predetermined ratio;
acquiring, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquiring a first ciphertext in which the first plaintext is encrypted;
acquiring, by using, among encryption results output from the encryption function in the encryption of the first plaintext, a value other than a value used for the encryption of the first plaintext and the second plaintext, a second ciphertext in which the second plaintext is encrypted; and
generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating an authentication tag.

### (Supplementary Note 19)

An authenticated decryption method comprising:
dividing a ciphertext into a first ciphertext and a second ciphertext at a predetermined ratio;
acquiring, by an encryption function corresponding to a cryptographic primitive of which an output length is longer than an input length and by using a mask value obtained based on a first value obtained by encrypting a nonce using the encryption function and a plurality of ciphertext blocks, respectively, obtained by dividing the first ciphertext into blocks each having a length corresponding to the input length, a plurality of plaintext blocks corresponding to the plurality of ciphertext blocks, and thereby acquiring a first plaintext obtained by decrypting the first ciphertext;
acquiring, by using, among encryption results output from the encryption function in the decryption of the first ciphertext, a value other than a value used for the decryption of the first ciphertext and the second ciphertext, a second plaintext obtained by decrypting the second ciphertext;
generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating a verification tag; and
verifying whether tempering has occurred or not by comparing the verification tag with an input authentication tag, and performing control for outputting a verification result.

### (Supplementary Note 20)

A program for causing a computer to perform:
a step of dividing a plaintext into a first plaintext and a second plaintext at a predetermined ratio;
a step of acquiring, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquiring a first ciphertext in which the first plaintext is encrypted;
a step of acquiring, by using, among encryption results output from the encryption function in the encryption of the first plaintext, a value other than a value used for the encryption of the first plaintext and the second plaintext, a second ciphertext in which the second plaintext is encrypted; and
a step of generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating an authentication tag.

### (Supplementary Note 21)

A program for causing a computer to perform:
a step of dividing a ciphertext into a first ciphertext and a second ciphertext at a predetermined ratio;
a step of acquiring, by an encryption function corresponding to a cryptographic primitive of which an output length is longer than an input length and by using a mask value obtained based on a first value obtained by encrypting a nonce using the encryption function and a plurality of ciphertext blocks, respectively, obtained by dividing the first ciphertext into blocks each having a length corresponding to the input length, a plurality of plaintext blocks corresponding to the plurality of ciphertext blocks, and thereby acquiring a first plaintext obtained by decrypting the first ciphertext;
a step of acquiring, by using, among encryption results output from the encryption function in the decryption of the first ciphertext, a value other than a value used for the decryption of the first ciphertext and the second ciphertext, a second plaintext obtained by decrypting the second ciphertext;
a step of generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating a verification tag; and
a step of verifying whether tempering has occurred or not by comparing the verification tag with an input authentication tag, and performing control for outputting a verification result.

Some or all of elements (e.g., structures and functions) specified in Supplementary Notes 2 to 8 dependent on Supplementary Note 1 may also be dependent on Supplementary Note 18 and Supplementary Note 20 in dependency similar to that of Supplementary Notes 2 to 8 on Supplementary Note 1. Similarly, some or all of elements (e.g., structures and functions) specified in Supplementary Notes 10 to 16 dependent on Supplementary Note 9 may also be dependent on Supplementary Note 19 and Supplementary Note 21 in dependency similar to that of Supplementary Notes 10 to 16 on Supplementary Note 9.

Some or all of elements specified in any of Supplementary Notes may be applied to various types of hardware, software, and recording means for recording software, systems, and methods.

What is claimed is:

1. An authenticated encryption apparatus comprising:
hardware, including a processor and memory;
a plaintext division unit implemented at least by the hardware and configured to divide a plaintext into a first plaintext and a second plaintext at a predetermined ratio;
a first encryption unit implemented at least by the hardware and configured to acquire, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquire a first ciphertext in which the first plaintext is encrypted;
a second encryption unit implemented at least by the hardware and configured to acquire, by using, among encryption results output from the encryption function in the encryption of the first plaintext, a value other than a value used for the encryption of the first plaintext and the second plaintext, a second ciphertext in which the second plaintext is encrypted; and
an authentication tag generation unit implemented at least by the hardware and configured to generate a first tag by the encryption function by using a value obtained based on an exclusive OR of some of the plurality of plaintext blocks and the mask value obtained based on the first value, generate a second tag by using a second value obtained by encrypting the nonce using the encryption function and the second ciphertext, and thereby generate an authentication tag.

2. The authenticated encryption apparatus according to claim 1, wherein the plaintext division unit divides the plaintext into the first plaintext and the second plaintext based on a ratio between the input length and a length obtained by subtracting the input length from the output length.

3. The authenticated encryption apparatus according to claim 1, further comprising a nonce processing unit implemented at least by the hardware and configured to encrypt the nonce using the encryption function, and thereby acquire the first value and the second value.

4. The authenticated encryption apparatus according to claim 1, wherein the first encryption unit acquires the first ciphertext by using an exclusive OR of, among encryption results output from the encryption function, a first random number having a number of bits corresponding to the input length and the plaintext block.

5. The authenticated encryption apparatus according to claim 4, wherein the second encryption unit acquires the second ciphertext by using an exclusive OR of a value and the second plaintext, the value being obtained by concatenating second random numbers other than the first random number among the encryption results output from the encryption function in the encryption process of the first plaintext.

6. The authenticated encryption apparatus according to claim 5, wherein the authentication tag generation unit generates the second tag by a function of a message authentication code by using the second value and the second ciphertext.

7. The authenticated encryption apparatus according to claim 1, further comprising a checksum calculation unit implemented at least by the hardware and configured to calculate a checksum based on an exclusive OR of some of the plurality of plaintext blocks.

8. The authenticated encryption apparatus according to claim 7, wherein the authentication tag generation unit generates the first tag by the encryption function by using an exclusive OR of the checksum and a mask value obtained based on the first value.

9. An authenticated decryption apparatus comprising:
hardware, including a processor and memory;
a ciphertext division unit implemented at least by the hardware and configured to divide a ciphertext into a first ciphertext and a second ciphertext at a predetermined ratio;
a first decryption unit implemented at least by the hardware and configured to acquire, by an encryption function corresponding to a cryptographic primitive of which an output length is longer than an input length and by using a mask value obtained based on a first value obtained by encrypting a nonce using the encryption function and a plurality of ciphertext blocks, respectively, obtained by dividing the first ciphertext into blocks each having a length corresponding to the input length, a plurality of plaintext blocks corresponding to the plurality of ciphertext blocks, and thereby acquire a first plaintext obtained by decrypting the first ciphertext;
a second decryption unit implemented at least by the hardware and configured to acquire, by using, among encryption results output from the encryption function in the decryption of the first ciphertext, a value other than a value used for the decryption of the first ciphertext and the second ciphertext, a second plaintext obtained by decrypting the second ciphertext;
a verification tag generation unit implemented at least by the hardware and configured to generate a first tag by the encryption function by using a value obtained based on an exclusive OR of some of the plurality of plaintext blocks and the mask value obtained based on the first value, generate a second tag by using a second value obtained by encrypting the nonce using the encryption function and the second ciphertext, and thereby generate a verification tag; and
a verification unit implemented at least by the hardware and configured to verify whether tempering has occurred or not by comparing the verification tag with an input authentication tag, and perform control for outputting a verification result.

10. The authenticated decryption apparatus according to claim 9, wherein the ciphertext division unit divides the ciphertext into the first ciphertext and the second ciphertext based on a ratio between the input length and a length obtained by subtracting the input length from the output length.

11. The authenticated decryption apparatus according to claim 9, further comprising a nonce processing unit implemented at least by the hardware and configured to encrypt the nonce using the encryption function, and thereby acquire the first value and the second value.

12. The authenticated decryption apparatus according to claim 9, wherein the first decryption unit acquires the first plaintext by using an exclusive OR of, among encryption results output from the encryption function, a first random number having a number of bits corresponding to the input length and the ciphertext block.

13. The authenticated decryption apparatus according to claim 12, wherein the second decryption unit acquires the second plaintext by using an exclusive OR of a value and the second ciphertext, the value being obtained by concatenating second random numbers other than the first random number among the encryption results output from the encryption function in the decryption process of the first ciphertext.

14. The authenticated decryption apparatus according to claim 13, wherein the verification tag generation unit generates the second tag by a function of a message authentication code by using the second value and the second ciphertext.

15. The authenticated decryption apparatus according to claim 9, further comprising a checksum calculation unit implemented at least by the hardware and configured to calculate a checksum based on an exclusive OR of some of the plurality of plaintext blocks.

16. The authenticated decryption apparatus according to claim 15, wherein the verification tag generation unit generates the first tag by the encryption function by using an exclusive OR of the checksum and a mask value obtained based on the first value.

17. An authenticated encryption method comprising:
dividing a plaintext into a first plaintext and a second plaintext at a predetermined ratio;
acquiring, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquiring a first ciphertext in which the first plaintext is encrypted;
acquiring, by using, among encryption results output from the encryption function in the encryption of the first plaintext, a value other than a value used for the encryption of the first plaintext and the second plaintext, a second ciphertext in which the second plaintext is encrypted; and
generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating an authentication tag.

18. An authenticated decryption method comprising:
dividing a ciphertext into a first ciphertext and a second ciphertext at a predetermined ratio;
acquiring, by an encryption function corresponding to a cryptographic primitive of which an output length is longer than an input length and by using a mask value obtained based on a first value obtained by encrypting a nonce using the encryption function and a plurality of ciphertext blocks, respectively, obtained by dividing the first ciphertext into blocks each having a length corresponding to the input length, a plurality of plaintext blocks corresponding to the plurality of ciphertext blocks, and thereby acquiring a first plaintext obtained by decrypting the first ciphertext;
acquiring, by using, among encryption results output from the encryption function in the decryption of the first ciphertext, a value other than a value used for the decryption of the first ciphertext and the second ciphertext, a second plaintext obtained by decrypting the second ciphertext;
generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating a verification tag; and
verifying whether tempering has occurred or not by comparing the verification tag with an input authentication tag, and performing control for outputting a verification result.

19. A non-transitory computer readable medium storing a program for causing a computer to perform:
a step of dividing a plaintext into a first plaintext and a second plaintext at a predetermined ratio;
a step of acquiring, by an encryption function corresponding to a cryptographic primitive of which an output length is longer than an input length and by using a mask value obtained based on a first value obtained by encrypting a nonce using the encryption function and a plurality of plaintext blocks, respectively, obtained by dividing the first plaintext into blocks each having a length corresponding to the input length, a plurality of ciphertext blocks corresponding to the plurality of plaintext blocks, and thereby acquiring a first ciphertext in which the first plaintext is encrypted;
a step of acquiring, by using, among encryption results output from the encryption function in the encryption of the first plaintext, a value other than a value used for the encryption of the first plaintext and the second plaintext, a second ciphertext in which the second plaintext is encrypted; and
a step of generating a first tag by the encryption function by using a value obtained based on an exclusive OR of some of the plurality of plaintext blocks and the mask value obtained based on the first value, generating a second tag by using a second value obtained by encrypting the nonce using the encryption function and the second ciphertext, and thereby generating an authentication tag.
